(19) United States
(12) Patent Application Publication
(10) Pub. No.: US 2012/0330719 A1
(43) Pub. Date: Dec. 27, 2012

(54) ENHANCED SYSTEMS, PROCESSES, AND USER INTERFACES FOR SCORING ASSETS ASSOCIATED WITH A POPULATION OF DATA

(76) Inventors: Ashutosh Malaviya, Cupertino, CA (US); Jia Ding, San Jose, CA (US); Jason Hiver Tondu, Coeur d'Alene, ID (US); Thomas Mark Glassanos, Pleasanton, CA (US); Avaneendra Gupta, San Jose, CA (US); Thomas Davidoff, Vancouver (CA)

(21) Appl. No.: 13/481,607

(22) Filed: May 25, 2012

Related U.S. Application Data
(60) Provisional application No. 61/490,928, filed on May 27, 2011.
(60) Provisional application No. 61/490,934, filed on May 27, 2011.
(60) Provisional application No. 61/490,939, filed on May 27, 2011.

(51) Int. Cl. G06Q 30/02

(52) U.S. Cl. 705/7.31

(57) ABSTRACT

Enhanced systems, processes, and user interfaces are provided for targeted marketing associated with a population of assets, such as but not limited to any of real estate or solar power markets. For example, the enhanced system and process may create an ordered list from a population of data, wherein the list may be optimized by the likelihood of a given event, such as but not limited to any of the selling of a home by owner, the transition of a property from non-distressed to distressed, or the purchase of solar equipment. In some embodiments, enhanced valuation models and price indices are provided for one or more assets that are associated with a population of data. As well, enhanced scoring systems and processes are provided for one or more assets that are associated with a population of data.

### CROSS REFERENCE TO RELATED APPLICATIONS

This Application Claims Priority to U.S. Provisional Application No. 61/490,928, entitled Targeting Based on Hybrid Clustering Techniques, Logistic Regression and Support Vector Machine Methods, filed 27 May 2011, to U.S. Provisional Application No. 61/490,934, entitled Clustering Based Home Price Index and Automated Valuation Model Utilizing the Neighborhood Home Price Index, filed 27 May 2011, and to U.S. Provisional Application No. 61/490,939, entitled Stochastic Utility Based Methodology for Scoring Real-Estate Assets Like Residential Properties and Markets, filed 27 May 2011, which are each incorporated herein in its entirety by this reference thereto.

### FIELD OF THE INVENTION

The present invention relates generally to the field of systems, processes and structures associated with determining an ordered list or score based upon a population of data. More particularly, the present invention relates to targeting and valuation systems, structures, and processes.

### BACKGROUND OF THE INVENTION

It is often difficult to predict the performance of sales and/or marketing over a large population, such as for one or more properties within a region.

For example, in domestic real estate markets, wherein thousands of properties are commonly associated within each region, property values are typically determined on a case by case basis, with a search of comparable properties in a neighborhood that have sold recently. As well, agents for a particular area often send out advertising materials to a large percentage of addresses within their region, with little knowledge of the likelihood that a particular addressee would be interested in contacting them to sell or buy a home.

It would therefore be advantageous to provide a system and/or process that improves the efficiency of sales or marketing of such assets. Such a development would provide a significant technical advance.

In other markets, such as for but not limited to the sales of solar power equipment, at the present time it is typically only a small percentage of properties that have already installed solar power systems, and it is extremely difficult to determine which land owners in any region may likely be interested in pursuing the purchase and installation of such a system. Therefore, it is often costly and ineffective to contact a large percentage of land owners or addressees within a region, with little knowledge of the likelihood that a particular addressee would be interested in contacting them to purchase or install a solar power system.

It would therefore be advantageous to provide a system and/or process that improves the efficiency of sales or marketing of such equipment. Such a development would provide a significant technical advance.

### SUMMARY OF THE INVENTION

Enhanced systems, processes, and user interfaces are provided for targeted marketing associated with a population of assets, such as but not limited to any of real estate or solar power markets. For example, the enhanced system and process may create an ordered list or score from a population of data, wherein the list or score may be optimized by the likelihood of a given event, such as but not limited to any of the selling of a home by owner, the transition of a property from non-distressed to distressed, or the purchase of solar equipment. In some embodiments, enhanced valuation models and price indices are provided for one or more assets that are associated with a population of data. As well, enhanced scoring systems and processes are provided for one or more assets that are associated with a population of data.

### BRIEF DESCRIPTION OF THE DRAWINGS

FIG. 1 is a basic flowchart of an exemplary enhanced process for determining an ordered list based upon a population of data;

FIG. 2 is a schematic view of an enhanced targeting system implemented over a network;

FIG. 3 is a schematic diagram of an exemplary computer system associated with an enhanced targeted system;

FIG. 4 is a functional block diagram of one or more targeted marketing segments that may be served with an enhanced targeting system and process;

FIG. 5 is a schematic diagram of an exemplary system for determining an ordered list based upon a population of data;

FIG. 6 is a functional block diagram of different targeting model creation processes associated with an enhanced targeting system;

FIG. 7 shows relative sizes and relationships within an exemplary region;

FIG. 8 is a chart that shows relative resolution and nesting relationships between different geographic units in the contiguous United States;

FIG. 9 is a flowchart of an exemplary process for geocoding and/or tagging for one or more properties;

FIG. 10 shows exemplary territories that may preferably be defined throughout one or more regions;

FIG. 11 is a flowchart of an exemplary process for applying one or more statistical models to a population of training data;

FIG. 12 is a schematic view of an exemplary embodiment of an enhanced automated value model system and process;

FIG. 13 is a schematic view of exemplary targeted marketing with of a predictive list through one or more channels;

FIG. 14 is a chart showing a plurality of assets, wherein each asset associated appreciation, holding period, and selling frequency, and wherein the assets form statistical clusters;

FIG. 15 is a detailed chart showing statistical clusters formed from a plurality of assets;

FIG. 16 is a flowchart of an exemplary enhanced clustering process;

FIG. 17 shows an enhanced user interface comprising an exemplary full listing of enhanced client targets;

FIG. 18 shows an exemplary door-knocking list of enhanced targeting for a corresponding agent, wherein the list is associated with an enhanced user interface;

FIG. 19 is a flowchart of an exemplary process for determining clusters in a population of data, for applying one or more valuation models to the data, and for segmenting the properties based upon the clustering and valuations;

FIG. 20 is a schematic chart showing a relationship between a schools rating for neighboring residential properties having different numbers of bedrooms;

FIG. 21 is a statistical regression tree associated with school ratings and different groups of neighboring residential properties;

FIG. 22 is a flowchart of an exemplary process for determining an enhanced market strength index;

FIG. 23 is a flowchart of an exemplary process for enhanced HPI and Appreciation;

FIG. 24 shows an exemplary repeat sales matrix for a single property;

FIG. 25 shows an exemplary enhanced user interface for displaying an automated estimate of an asset, e.g. a residential property;

FIG. 26 shows a listing of sales and asset information for comparable properties within an exemplary enhanced user interface;

FIG. 27 shows detailed asset information, in addition to statistical information and a list of sales and asset information for comparable assets, within an exemplary enhanced user interface;

FIG. 28 is a display of enhanced neighborhood price index information, within an exemplary enhanced user interface;

FIG. 29 is a flowchart of an exemplary process for determining home and investor scores;

FIG. 30 is a graph showing utility of assets as a function of return;

FIG. 31 is an exemplary correlation matrix for a plurality of asset attributes;

FIG. 32 is an exemplary enhanced rating display for an asset within a exemplary enhanced user interface, with a comparison of the rating of the asset to comparable assets within different statistical regions;

FIG. 33 shows an enhanced display of enhanced risk ratings;

FIG. 34 shows an enhanced display of financial analysis; and

FIG. 35 is a flowchart for an exemplary process to determine an enhanced rental score.

### DETAILED DESCRIPTION OF PREFERRED EMBODIMENTS

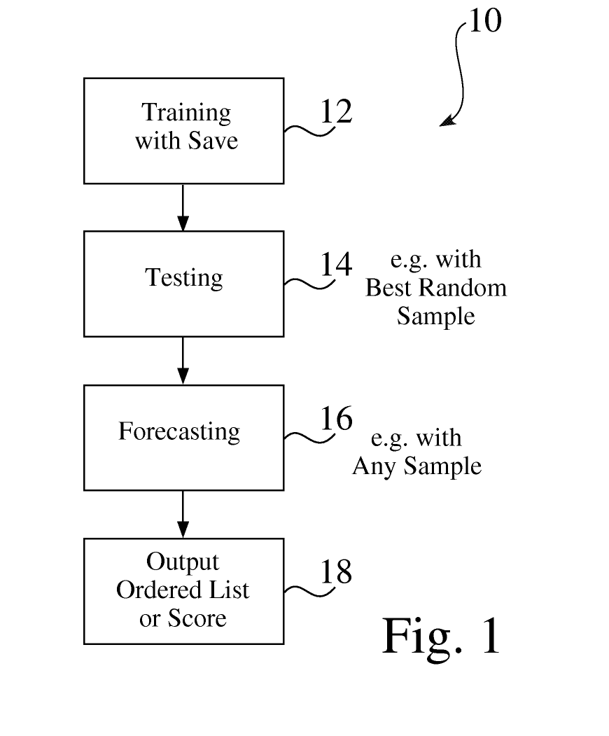

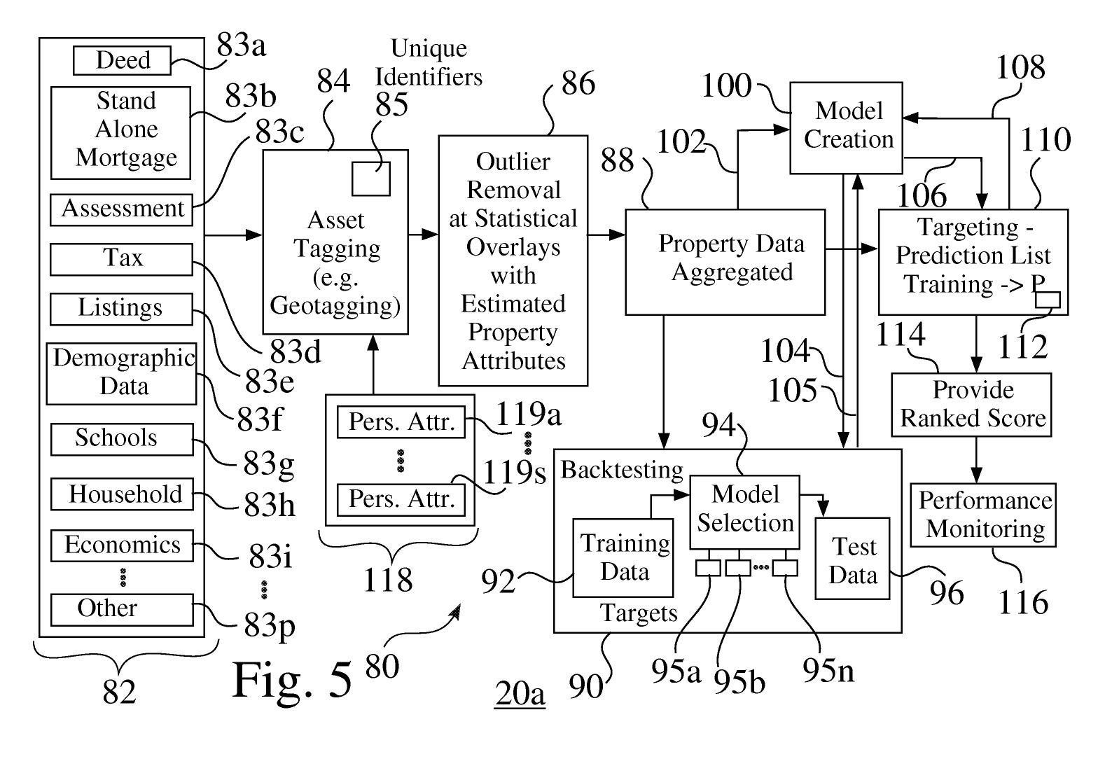

FIG. 1 is a basic flowchart of an exemplary enhanced process 10 for determining an ordered list or score based upon a population of data 82 (FIG. 5). For example, using a portion of a population of data 82 for which information is known over a known period, e.g. over the past 6 months or 12 months, one or more training models 95, e.g. 95a-95j (FIG. 5) may be applied to the data 82, to determine the performance of the training models 95 over time, such as to determine which of the models 95 appear to yield the best results, i.e. produce forecasted results that are consistent with data values based on the end of the known period, or to determine how one or more of the models 95 may be improved to more accurately predict the results as compared to known data 82.

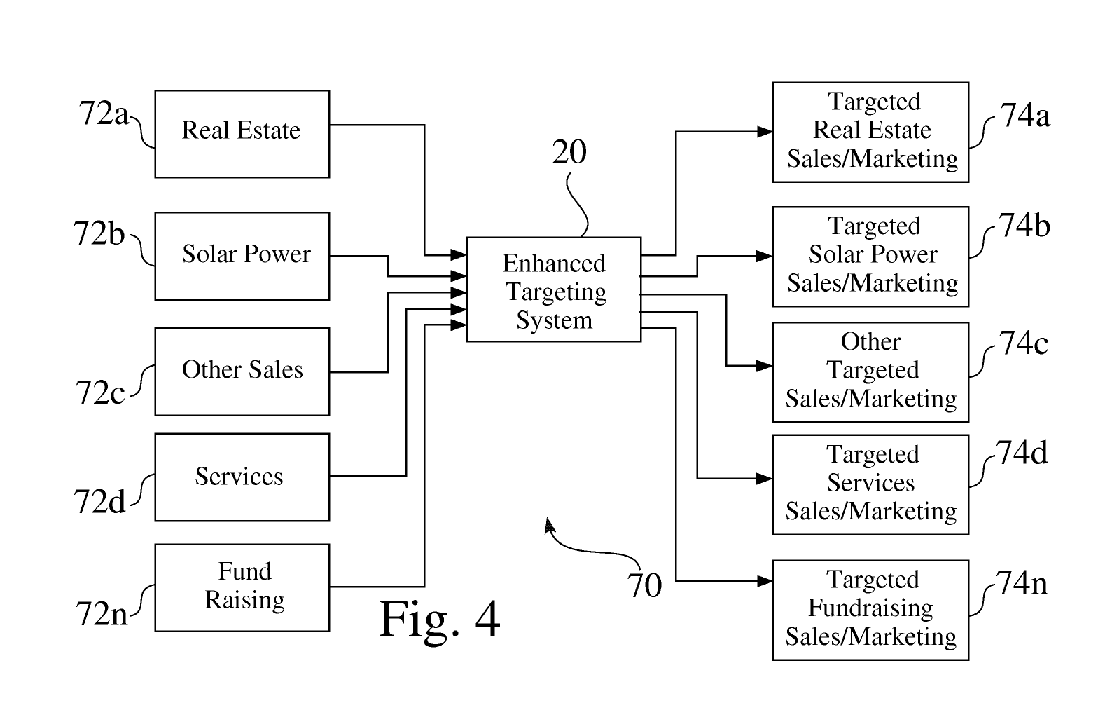

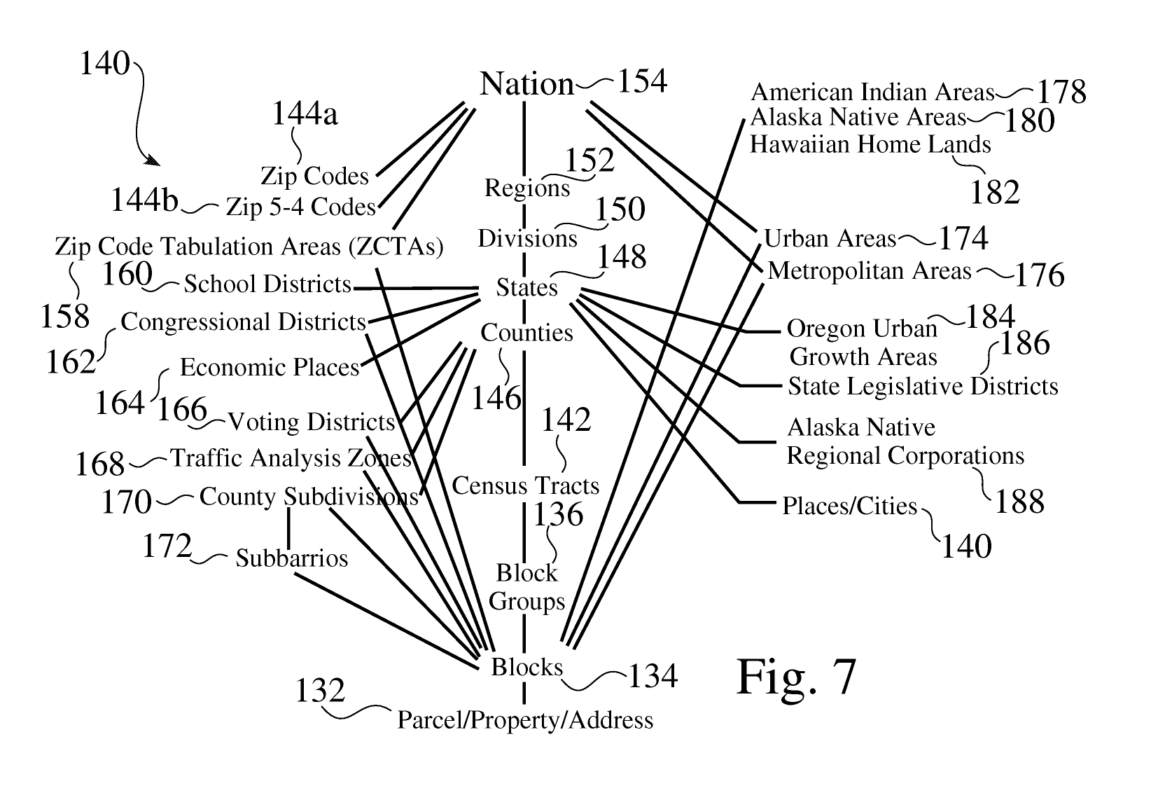

After a training period, further testing 14 is performed on a different sample, e.g. another random sample, of the population of data 82, to determine whether the trained models 95 yield adequate performance with a different sample of the population of data 82. If the testing step 14 is successful, the forecasting model 95 may then be applied to any sample within a chosen population of data 82, such as to create an ordered list 112, (FIG. 5) from at least a portion of the population of data 82, wherein the list 112 may be optimized by the likelihood of a given event, such as but not limited to any of the selling 74a (FIG. 4) of a home or property 132 (FIG. 7) by the owner, the transition of a property 132 from non-distressed to distressed, e.g. 74c (FIG. 4), or the sales or marketing of solar equipment 74b (FIG. 4).

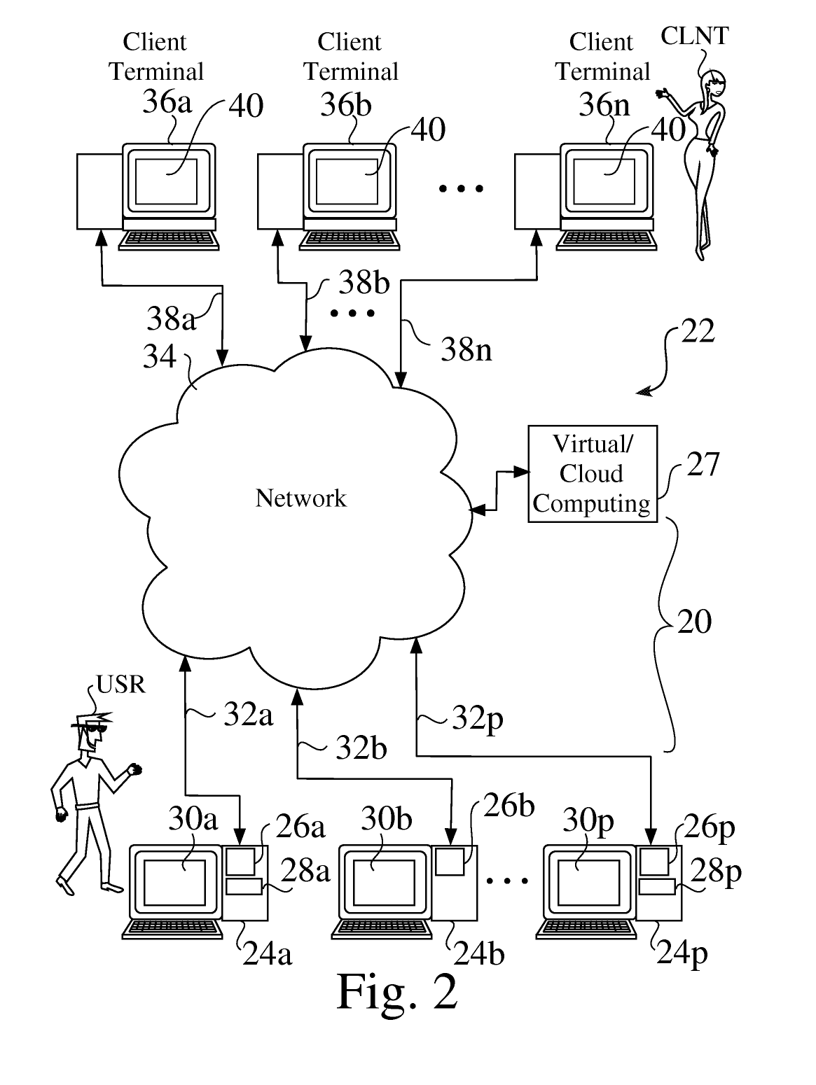

FIG. 2 is a schematic view 22 of an enhanced targeting system 20 implemented over a network 34, e.g. the Internet 34. For example, the system 20 may be implemented over one or more terminals 24, e.g. 24a-24p, wherein each of the terminals 24 comprises a processor 26, e.g. 26a, and a storage device 28, e.g. 28a. As well, an interface 30, e.g. 30a, may be displayable to a user USR at one or more of the terminals 24, and the terminals 24 may preferably be connectable to the network 34, e.g. the Internet 34.

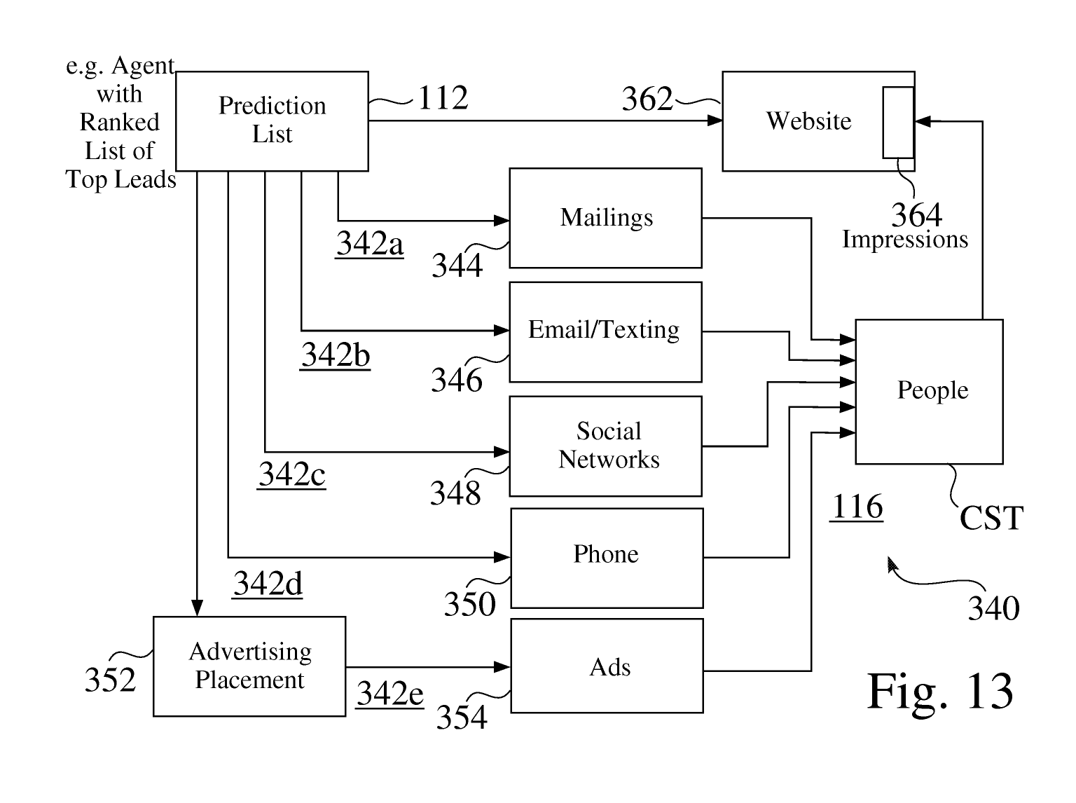

As also seen in FIG. 2, one or more client terminals 36, e.g. 36a-36n, may be connectable 38, e.g. 38a-38n, to the network 34, such as to communicate with the system 20, and/or to receive information, e.g. such as but not limited to a ranked list or score 112, from the system 20. A user interface 40 may preferably be displayed at the client terminals 36, wherein a client CLNT can readily examine and navigate through targeted sales and/or marketing information that is received from the system 20. The client terminals 36 may comprise a wide variety of nodes, such as but not limited to any of desktop computers, portable computers, wired or wireless devices, e.g. portable digital assistants, smart phones, and/or tablets. As well, the system 20 may send, distribute, or otherwise disseminate information as a hard copy or document to a client CLNT or to a customer CST (FIG. 13).

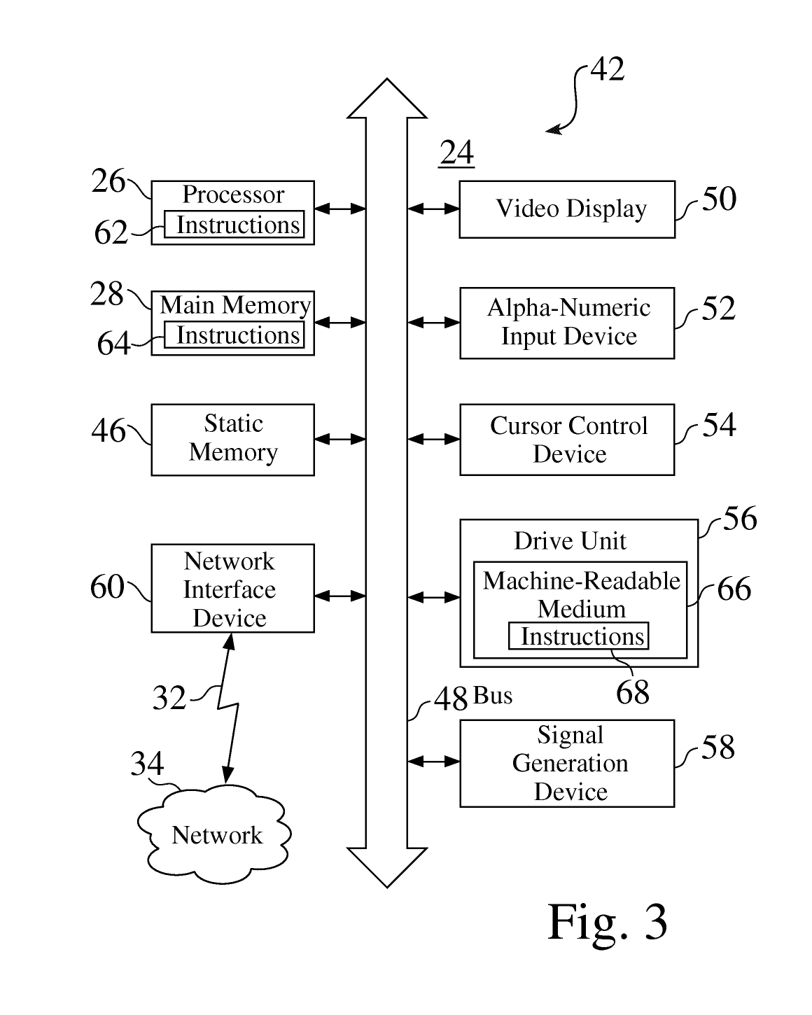

FIG. 3 is a block schematic diagram 42 of a machine in the exemplary form of a computer system 24 within which a set of instructions may be programmed to cause the machine to execute the logic steps of the enhanced system 20. In alternative embodiments, the machine may comprise a network router, a network switch, a network bridge, personal digital assistant (PDA), a cellular telephone, a Web appliance or any machine capable of executing a sequence of instructions that specify actions to be taken by that machine.

The exemplary computer system 24 seen in FIG. 3 comprises a processor 26, a main memory 28, and a static memory 46, which communicate with each other via a bus 48. The computer system 24 may further comprise a display unit 50, for example, a light emitting diode (LED) display, a liquid crystal display (LCD) or a cathode ray tube (CRT). The exemplary computer system 24 seen in FIG. 3 also comprises an alphanumeric input device 52, e.g. a keyboard 52, a cursor control device 54, e.g. a mouse or track pad 54, a disk drive unit 56, a signal generation device 58, e.g. a speaker, and a network interface device 60.

The disk drive unit 56 seen in FIG. 3 comprises a machine-readable medium 66 on which is stored a set of executable instructions, i.e. software 68, embodying any one, or all, of the methodologies described herein. The software 68 is also shown to reside, completely or at least partially, as instructions 62,64 within the main memory 28 and/or within the processor 26. The software 68 may further be transmitted or received 32 over a network 34 by means of a network interface device 60.

In contrast to the exemplary terminal 24 discussed above, an alternate terminal or node 24 may preferably comprise logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complimentary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core, e.g. such as the CPU of a computer, or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Further, it is to be understood that embodiments may include performing computations with virtual, i.e. cloud computing 27 (FIG. 2). For the purposes of discussion herein, cloud computing may mean executing algorithms on any network that is accessible by internet-enabled devices, servers, or clients and that do not require complex hardware configurations, e.g. requiring cables, and complex software configurations, e.g. requiring a consultant to install. For example, embodiments may provide one or more cloud computing solutions that enable users, e.g. users on the go, to print using dynamic image gamut compression anywhere on such internet-enabled devices, servers, or clients. Furthermore, it should be appreciated that one or more cloud computing embodiments include printing with dynamic image gamut compression using mobile devices, tablets, and the like, as such devices are becoming standard consumer devices.

FIG. 4 is a functional block diagram 70 of one or more targeted marketing segments 72, e.g. 72a-72n, that may be served with an enhanced targeting system 20 and associated processes, e.g. 10 (FIG. 1), 80 (FIG. 5). For example, the enhanced targeting system 20 may provide targeted marketing and/or sales information 74a based upon a population of real estate data 72a. The enhanced targeting system 20 may alternately provide targeted solar power system marketing and/or sales information 74b based upon a population of data 72b. The enhanced targeting system 20 may preferably be adapted to provide other sales or marketing information 74, e.g. 74c-74n, such as based upon corresponding received data 72, e.g. 72c-72n.

FIG. 5 is a schematic diagram 80 of an exemplary system 20a for determining an ordered list or score 112 based upon a population of data 82. The exemplary system 20a seen in FIG. 5 may preferably provide targeted marketing and/or sales for real estate, wherein a population of data 82 is input or otherwise received in regard to a plurality of properties 132 (FIG. 7).

The population of data 82 seen in FIG. 5 may preferably comprise a plurality of attributes 83, e.g. 83a-83p, for assets, e.g. properties 132. For example, for assets that comprise real estate properties 132, exemplary attributes 83, e.g. 83a-83p, may comprise any of deed information 83a, stand alone mortgage information 83b, property assessment information 83c, tax information 83d, listing information 83e, demographic data 83f, schools information 83g, household information 83h, economics information 83i, other information 83p, and/or any combination thereof. Some of the attributes 83 seen in FIG. 5 may be unique to a particular property 132, while other attributes 83 may be common to more than one property 132.

As also seen in FIG. 5, geocoding or tagging 84 may preferably be performed on the population of data 82, such as to create a standard address identifier and/or a unique identifier 85 for all the geographies. As well, a data processing module 86 may preferably operate on the data 82, such as to remove outlier data values, e.g. by using statistical overlays with estimated property attributes. For example, erroneous or missing attribute values 83 for one or more properties 132 may be adjusted or estimated, based on other attributes 83 of the property 132, and/or based on attributes of other properties 132 that are determined to be statistically similar.

As additionally seen in FIG. 5, a second population of data 118 may preferably be processed by the system 20a, such as comprising one or more attributes 119, e.g. 119a-119s, for a population of people 118, e.g. such as but not limited to potential or existing customers CST. Exemplary attribute information 119 for a population of people 118 may comprise but is not limited to any of income, level of education, interests, spending patterns, Internet browsing patterns, travel patterns, activities, profession, friends, and/or associates. As with other assets 132, the system 20a may preferably assign a unique identifier or tag 85 to each person in the second population of data 118. The system 20a may preferably provide forecasting using the second population of data 118, either alone or in combination with the first population of data 82. For example, the system 20a may preferably predict the intent of one or more people, such as based on their attributes alone, or in combination with other people in the second population of data 118 that are determined to be statistically similar.

As further seen in FIG. 5, the property data 82 may preferably be aggregated 88, at which point, the aggregated property data 88 may be available to a presales assessment module 90, such as for model training 92, model testing 96, and model selection 94.

The presales assessment (PSA) 90 comprises a primary phase of the enhanced prediction process 80, such as comprising steps 12 and 14 in the enhanced process 10 seen in FIG. 1, wherein an assessment of feasibility is undertaken by performing back testing of prediction model performance. The exemplary presales assessment (PSA) 90 seen in FIG. 5 comprises the application of one or more prediction models 95, e.g. 95a-95n on a set of training data 82, wherein the training data 82 corresponds to a known period e.g. over a proceeding 6 month and/or 12 month period, to determine the predictive performance of the predictive models 95. For example, for a random collection of properties 132 in one or more regions, the training step 92 may predict changes in valuation over a known period, wherein the prediction values are compared to the actual changes in valuation.

When the training step 92 is completed, changes to one more prediction models 95 may be made, which may then be followed by returning to the training step 92, to determine if the changes have improved the predictive performance of the modified prediction models 95. When it is determined that one or more of the models 95 provides acceptable performance with the training data 82, the chosen models 95 may then preferably be used to perform predictive testing on a different sample of training data 82, such as collected over the same known period, e.g. a proceeding 6 month and/or 12 month period, to determine the predictive performance of the predictive models 95 with a different sample of the population of data 82.

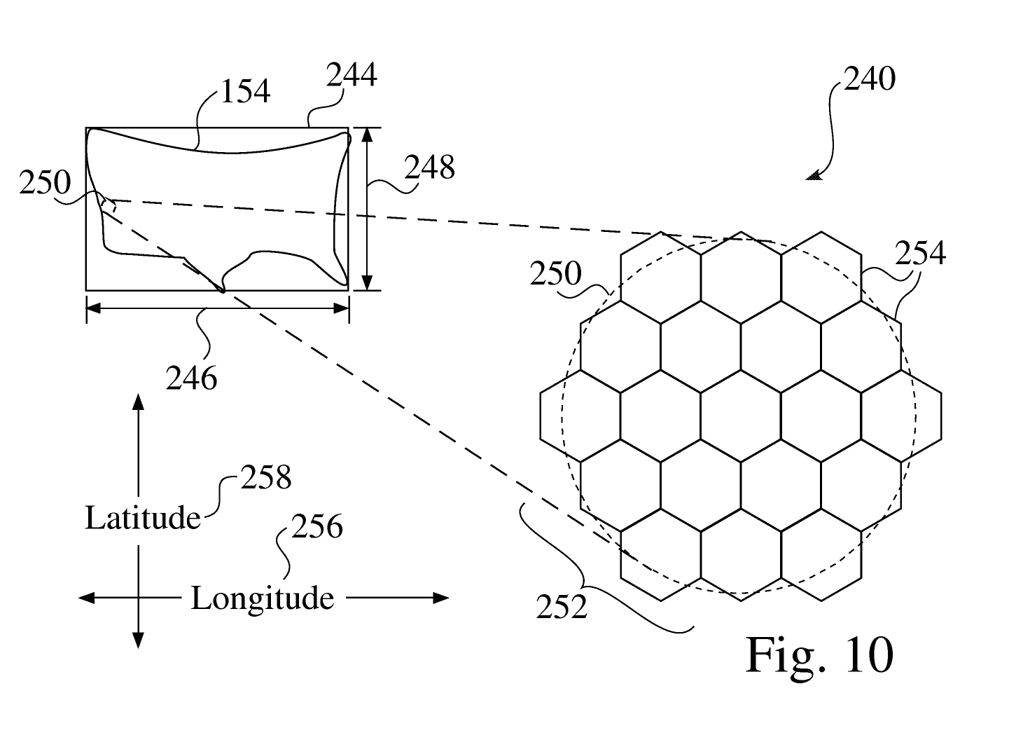

The selection of one or more models 95 for a logistic regression model 95 may preferably be made in a manner that is similar to Fuzzy C-Means cluster selection, as described below. For example, for a plurality of regression models 95, e.g. 10 models 95, predictions of performance may be made using sample training data 82 that is dated for a specified period, e.g. historic 6-month or 12-month data. A prediction ratio, i.e. an income multiplier, may then preferably be calculated for each of the regression models 95, using the sample test data set. Based upon the output from each of the models 95, a model 95 may preferably be chosen, such as based on the highest prediction ratio output. The model selection process allows for the set of models 95 to be used or selected for one or more territories 254 (FIG. 10) that may differ in input characteristics. For example, the availability or absence of certain data, e.g. square footage, transactional information, may constrain the selection of one or models 95.

After testing 96 is determined to be successful, the process proceeds to a second primary stage 110 of the process 80, wherein a prediction list or score 112 is generated, by applying a selected predictive model 95 to aggregated data 88, such as aggregated data 88 that corresponds to a territory 254 of interest for a client CLNT. The prediction list 112 may preferably be ordered, ranked, or otherwise scored or presented, to demonstrate the likelihood of satisfying an objective function, such as the likelihood of selling a house. For example, a portion 114, e.g. the highest 20 percent of ranked properties 132, may be presented to a client CLNT, e.g. an agent, who can then focus marketing efforts on customers CST (FIG. 13) who are most likely to list their property 132 for sale, or in another system embodiment 20, are determined to be most likely to be interested in acquiring a solar power generation system.

After the client CLNT receives the ranked marketing information 112,114, the system 20a may preferably provide continuous performance monitoring 116 and time based list correction, such as on a periodic basis, e.g. on a monthly frequency.

Exemplary model creation 100, application 104,106 and updating 108 are also indicated in FIG. 5. For example, at least a portion 102 of the aggregated data 88 may preferably be considered when developing a predictive model 95. In some embodiments of the system 20a and process 80, one or more of the prediction models 95 may comprise any of temporal models, spatial models, and/or spatial temporal models, or any combination thereof.

A creation model 95 may preferably be sent 104 or otherwise accessed by the presales assessment module 90, e.g. such as for data training 92 or data testing 96. As well, a selected creation model 95 may preferably be sent 106 or otherwise accessed by the prediction module 110, e.g. such as to operate on data that corresponds to a territory 254 (FIG. 10), to provide a ranked predictive list 112 for that territory 254. One or more predictive models 95 may preferably be updated, optimized, or fine tuned by the model creation module 100, such as based upon feedback 108, or from performance monitoring 116, wherein the system may track any of events, leads, ads 354 (FIG. 13), and/or impressions 364 (FIG. 13).

The enhanced targeting system 20 and associated process 10,80 thus creates an ordered list or score 112 from a population of data 82, wherein the output is optimized by the likelihood of a given event, e.g. such as but not limited to any of the selling of a home by owner, the transition of a property 132 from non-distressed to distressed, or the purchase of solar equipment.

For real estate applications, e.g. 72a (FIG. 4), the enhanced targeting system 20 and associated process 10,80 combine the power of predictive real estate analytics with seller prospecting, to give agents CLNTs the insights on which properties 132 in their territory, e.g. 254, are more likely to sell, so that they can focus their efforts, accelerate their leads, and grow their listings business.

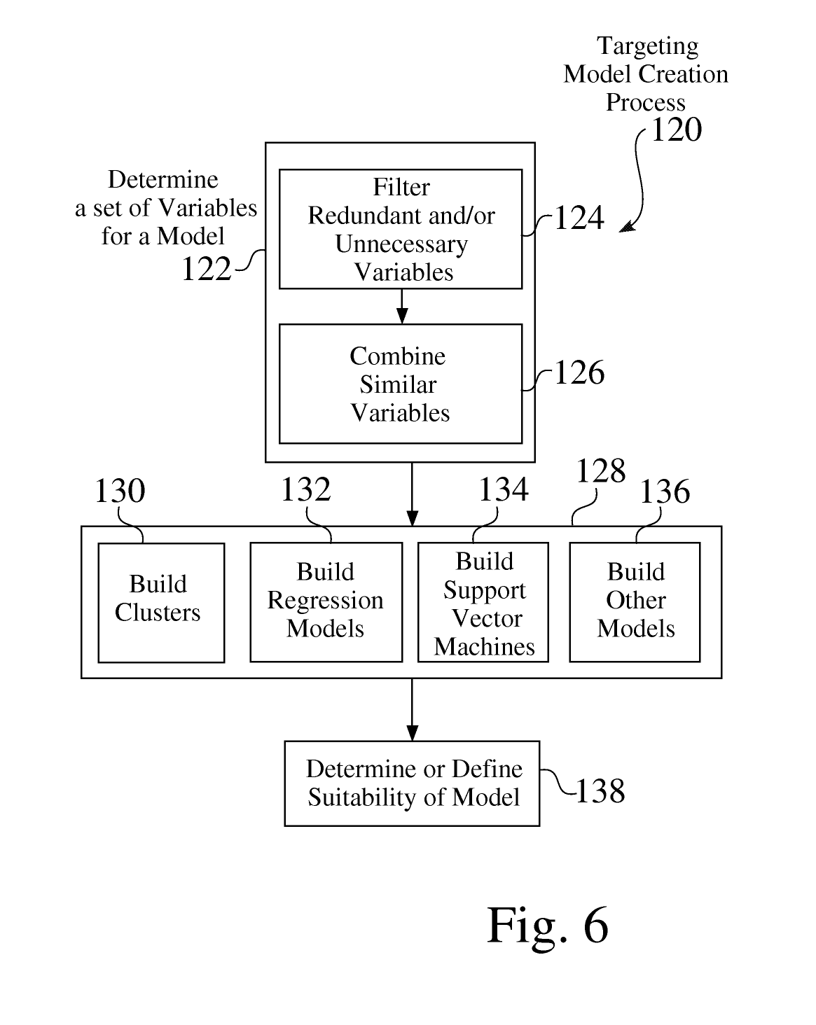

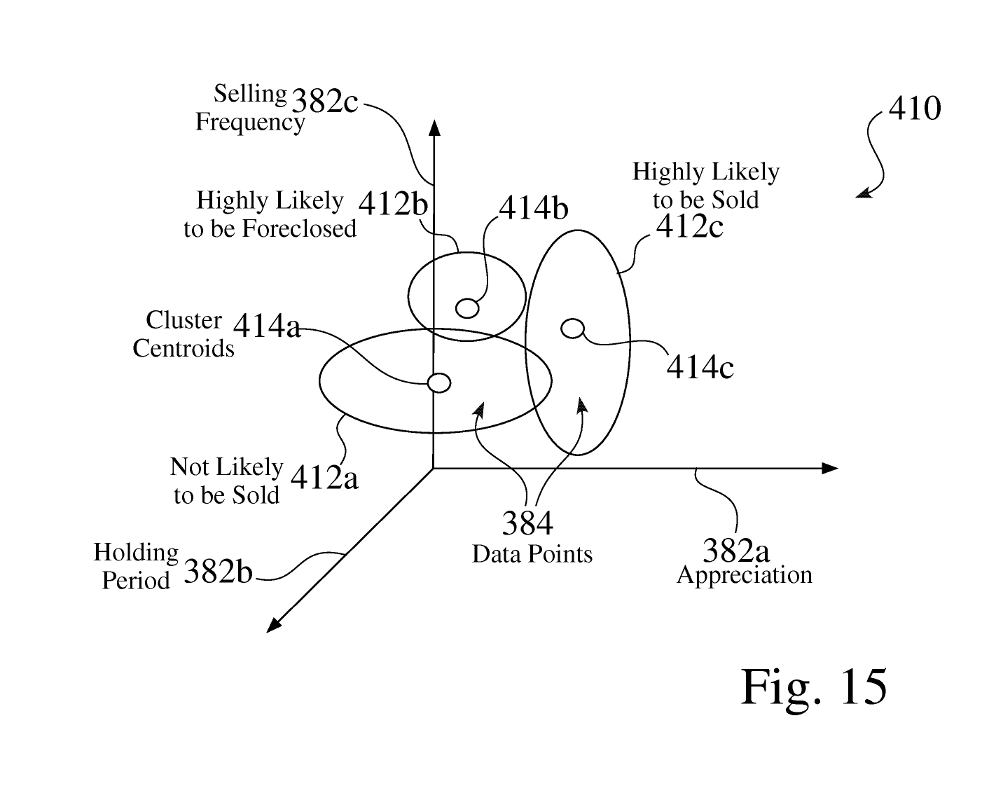

FIG. 6 is a functional block diagram of an exemplary model creation process 120 associated with an enhanced targeting system 20, such as provided through the model creation module 100 (FIG. 5). In a first primary step 122 the process determines a set of variables for a model 95, such as based on a large number of attributes 83, e.g. some or all of attributes 83a-83p (FIG. 5). At step 124, any attributes or variables 83 that are determined to be redundant and/or unnecessary are filtered or cleared from the model 95. As well, attributes or variables 83 that are determined to be similar may preferably be combined 126. When the set of variables 83 are determined 122, the prediction model is built 128, such as by building clusters 412, e.g. 412a-412c (FIG. 15) at step 130, by building one or more regression models 132, by building one or more support vector machines 134, and/or by building other models 136.

At step 138, the process 120 may determine or define the suitability of a prediction model 95, such as based on but not limited to territory, e.g. 254 (FIG. 10) or a state 148 (FIG. 10), the availability of one or more data attributes 83, and/or the absence of one or more data attributes 83. For example, some data attributes 83 may not be published or otherwise available for some states 148, e.g. Texas, so a prediction model 95 that requires the missing attribute 83 may preferably either be selected but compensate for the missing data attribute 83, or may otherwise not be selected as a suitable prediction model 95 for the prediction step 110.

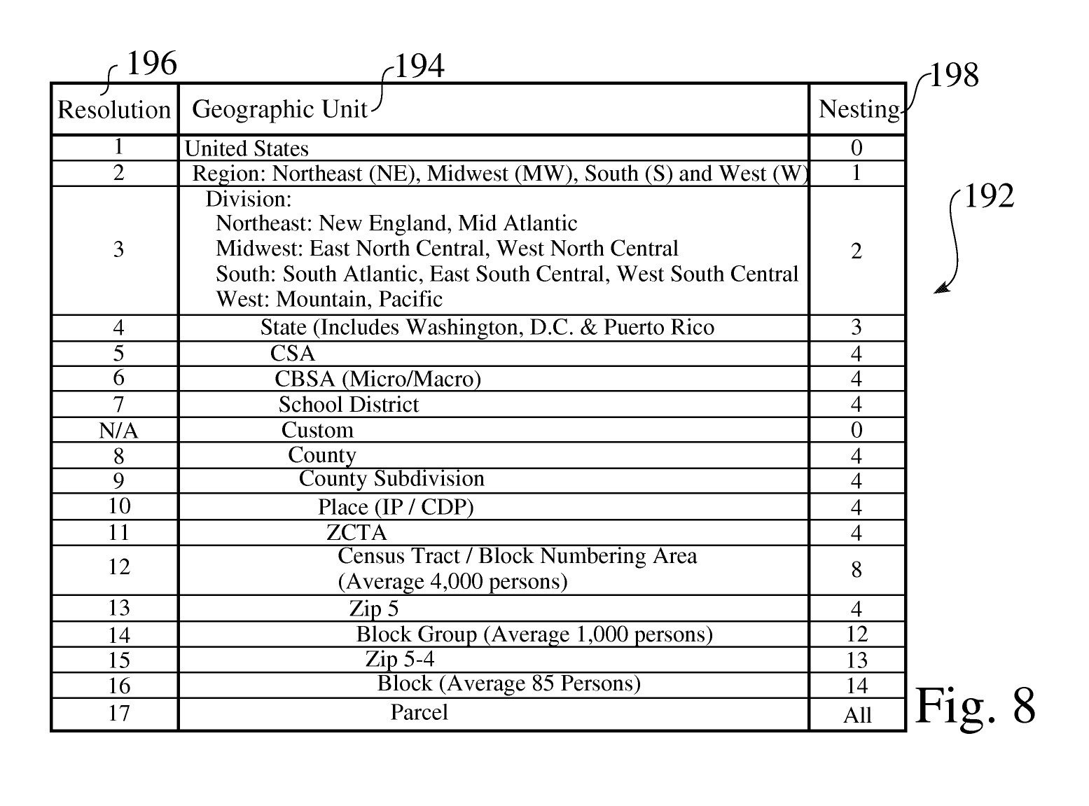

FIG. 7 is a schematic view 140 that shows relative sizes and relationships between different exemplary areas, such as within a nation 154, e.g. the United States 154. FIG. 8 is a chart 192 that shows relative resolution 196 and nesting relationships 198 between different geographic 194 units in the United States.

As seen in FIG. 7 and FIG. 8, within the United States 154, a plurality of regions 152 are typically designated, such as comprising the Northeast (NE), the Midwest (MW), the South (S), and the West (W). Within each national region 152, a plurality of divisions 150 are designated, as seen in greater detail in FIG. 8. Each division 150 includes a plurality of states 148. Within the United States 154, Washington D.C. and Puerto Rico are also typically considered to be on the state level 148. Within each state 148, a plurality of counties 146 are designated, and each county 146 is made up of many census tracts 142. The average population of a census tract 142 is currently about 4,000 people. Within each census tract 142, a plurality of block groups 136 are designated, wherein the block groups each comprise a plurality of blocks 134. The average population of a block group 136 is currently about 1,000 persons, while the average population of a block is currently about 85 people. Each block 134 comprises a plurality of parcels, e.g. properties 132, which correspond to an address.

Areas within United States 154 are also designated by a variety of other identifying groups, such as any of zip codes 144, e.g. Zip 5 codes 144a and Zip 5-4 codes 144b, Zip Code Tabulation Areas (ZCTAs) 158, school districts 160, congressional districts 162, economic places 164, voting districts 166, traffic analysis zone 168, county subdivisions 170, subbarrios 172, urban areas 174, metropolitan areas 176, American Indian Areas 178, Alaska Native Areas 180, Hawaiian Home Lands 182, Oregon Urban Growth Areas 184, State Legislative Districts 186, Alaska Native Regional Corporations 188, and places 190.

The different exemplary regions seen in FIG. 7 and FIG. 8 therefore make up some of the attributes that are assignable to each property 132, wherein a property 132 can uniquely be defined by its unique location, and by the geographic units 194 to which it belongs.

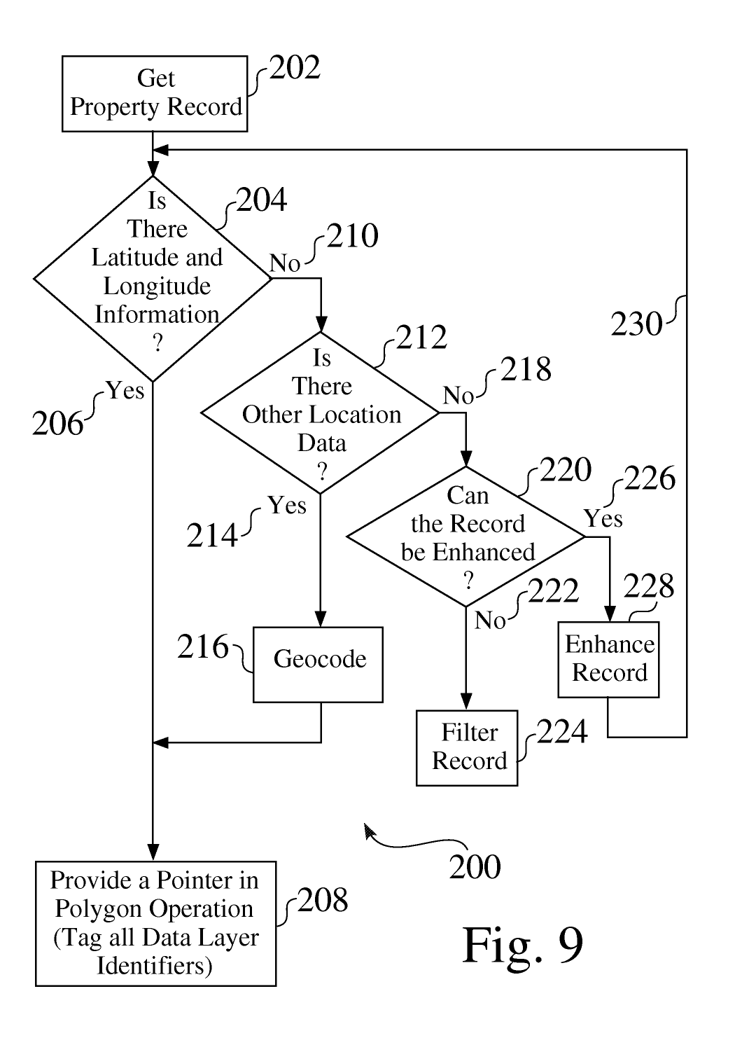

FIG. 9 is a flowchart of an exemplary process 200 for geocoding and/or tagging for one or more properties 132, such as provided during asset tagging 84 (FIG. 5). At step 202, the process 200 gets a property record associated with a property, i.e. parcel 132. At step 204, a determination is made whether the acquired record data includes the corresponding latitude and longitude information for the property 132. If so 206, the process 200 provides 208 a pointer that uniquely corresponds to the property 132, such as in a polygonal operation, wherein the system tags all associated data layer identifiers. If the decision 204 is negative 210, the process 200 determines 212 if there is other location data available for the property 132. If so, the process applies 216 a geocode for the property 132, and proceeds to the pointing and tagging step 208. If the decision 212 is negative 210, the process 200 determines 220 whether the record can be enhanced. If not 222, the process 200 filters 224 the record associated with the property 132, such that data attributes 83 for that property may preferably be removed 86 (FIG. 5) from the data aggregation 88 (FIG. 5). If the record associated with the property 132 can 226 be enhanced, the process 200 enhances 228 the record, and returns 230, wherein the process 200 can retry to tag the property 132.

FIG. 10 is a schematic view 240 that shows exemplary territories 254 that may preferably be defined throughout one or more regions. For example the contiguous United States 154 extends over a wide region, wherein the northwest most point corresponds to 49.384358 North Latitude and 124.771694 West Longitude, while the southeast-most point corresponds to 24.52083 North Latitude and 66.949778 West Longitude. Therefore, the contiguous United States 154 lies in a region 244 that extends 57.821916 degrees 246 in longitude 256, and 24.52083 degrees 248 in latitude 258.

Within this region 244, a large number of territories 254 may preferably be defined, such as but not limited to hexagonal regions 254. The exemplary territories 254 seen in FIG. 10 may preferably be established to extend over the contiguous United States 154, and/or over other regions. The exemplary hexagonal shaped tracts 254 seen in in FIG. 10 are repeated to form an array 252, such that each property 132 may be uniquely assigned to a hexagonal tract 254.

Territories 254 may preferably be segmented based on more one more parameters. For example, real estate territories 254 may be based on any of neighborhoods, schools, or other predefined sales regions. For solar markets, territories 254 may preferably be based on Zip codes 144 or cities/places 140. For other system embodiments 20, territories 254 may be based on metropolitan areas 176, i.e. metros 176 (FIG. 7). As well, one or more markets 72 (FIG. 4) and/or territories 254 may preferably be based on standard or custom demographics, or geographies, such as based on any of lifestyle, crime and/or schools.

Enhanced Predictive Targeting for Solar Marketing. As noted above, an enhanced system 20 and process 10,80 may preferably be suitably adapted to provide targeted predictive marketing 72b for solar power systems. Exemplary data 82 to be input may preferably comprise dependent variables, such as a binary pv flag that is determined through the scanning of publically available satellite imaging. Independent variables are input, such as property level data and block group level data. Exemplary property level data may comprise any of building Square feet, valuation, e.g. AVM, year built, and/or loan to value information. Exemplary block group level data may comprise any of population, population density, median age, and/or income.

Solar Targeting Model Evaluation. Enhanced solar targeting models are estimated using a logistic regression, which is complimented by a Monte Carlo simulation, to ensure model robustness. Since the data does not include a temporal component, the total data set is randomly divided into two equal components: a testing set and a training set. Due to the sparse nature of the event data, such as indicated by the pv flag, prior to model estimation, the training data is preferably sampled, to artificially increase the event rate, based on elements with a pv flag of 1.

The sampling is done by taking the full population of events, i.e. any events with a pv flag of 1, and a proportion of randomly drawn non-events, i.e. having a pv flag of 0, using a specified event rate. For example, given an event rate of 1:49, for each event noted in the data sample, 49 non-events will be randomly drawn from the larger population of nonevents, yielding an in-sample event rate of 2%.

Once an artificial sample population is generated, a proposed logistic model is estimated, using maximum likelihood estimation. The resultant coefficient and variable significances are then saved. The data randomization/division, artificial sampling and estimation process is then repeated, to generate new coefficients and significance values a minimum of 25 times, dependent on the volatility of the input data.

Once the simulation process is completed, average variables significances are calculated as an unweighted mean. Dependent on average variable significances, variables which have low significances are dropped, and new variables are added, which results in a new model specification, and a re-initialization of the entire process.

If a new model speciation returns a lower Akaike Information Criteria (AIC), after all insignificant variables are removed, the new specification is maintained. Alternatively, if a new specification returns a higher AIC, the new model is rejected and the model selection process reverts to the previous specification, and tests another alternative specification.

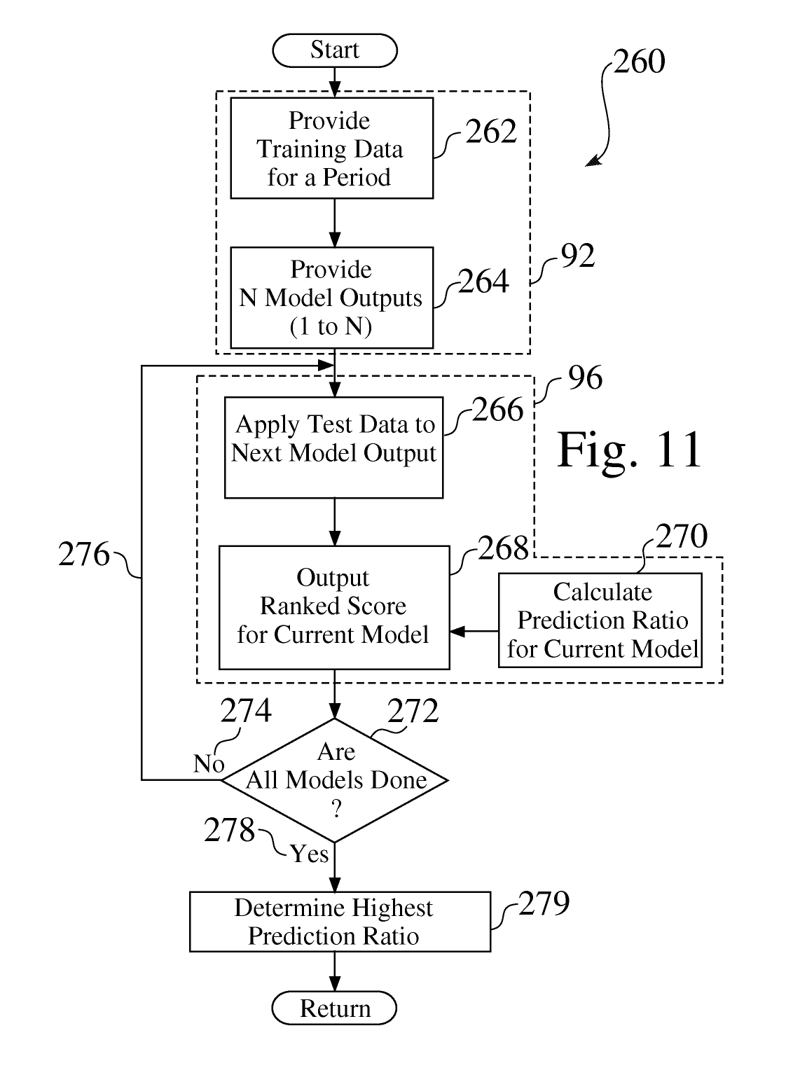

After an exhaustive search of likely model specifications is completed and a final model is selected, the model outputs are simulated over a minimum of 50 iterations, as described above. For each output generated using the test dataset, a prediction ratio 270 (FIG. 11) is generated and stored. The final prediction ratio of the winning model is calculated as the unweighted mean of the simulated prediction ratios. If this final averaged prediction ratio clears a minimum threshold, e.g. 2.0, the chosen model is then used to generate a forecast result.

In the forecasting stage, the model may preferably be evaluated a minimum of 50 times over the full span of artificial generated data. There is typically no division between training and testing for predictive processes 10,80 aimed at solar marketing 72b, since there is typically no historical data to train 12, 92. Each element in the dataset is assigned an associated probability. The unweighted mean of these probabilities over the simulated runs then generates the final prediction list 112.

Post-Model Processing for Solar Marketing. After a prediction list is generated, a stack ranked list 112, which is ordered by probability is created. This stack-ranked list 112 is then further processed through a filtering process, which suppresses properties which are considered undesirable for business reasons. Such reasons may comprise any of having a low credit rating, having limited roof space, being owned by an absentee owner, or being an underwater or delinquent property. The filtering process works by separating the full list into two populations: elements that are suppressed, and elements that are not suppressed. The probability stack ranked list 112 of unsuppressed elements is then inserted above the probability stack list of suppressed elements, regenerating a full list.

FIG. 11 is a flowchart of an exemplary process 260 for applying one or more statistical prediction models 95 to a population of training data 82. For example, the system 20, e.g. 20a, may provide 262 training data 82 for a determined period, e.g. such as over a 6 month or twelve month period. At step 264, one or more prediction models 95, e.g. 95a-95n, may preferably be provided for training 92 (FIG. 5), wherein one or more of the models 95, is eventually run 266 with the test data 96 for the determined period. The results of step 266 are then output 268, such as to successively provide a ranked score, e.g. ranked household probabilities (RHC), for each model 95. As seen at step 272, if all the models 95 have not 274 been tested, the process returns 276 to run 266 the next model 95 with the same test data 96. If, at step 272, all testing 266 has been completed for all the models 95, process 260 may output a set of results for each of the predictive models 95, e.g. for ten predictive models 95, the output may preferably comprise ten sets of ranked scores, such as but not limited to ranked household probabilities.

As seen at step 270, the process 260 may preferably calculate a prediction ratio, for each model 95, which comprises a relative density measure of opportunities, to arrive at the ranked score 268. In some process embodiments 260, the prediction ratio is considered to be an income multiplier.

At step 279, the different sets of output 268 are compared to known data from the end of the determined test period, to determine the performance of each of the predictive models 95, such as to determine which if any of the predictive models 95 accurately predict the events seen in the data, e.g. such as but not limited to:
which homes 132 have been listed;
which homes 132 have been sold;
the average time on market;
property appreciation;
home values; and/or
transitions of properties 132 between distressed and not distressed.

At step 279, feedback or tuning 105 (FIG. 5) of one or more prediction models 95 may also be performed, such as based on a determination that one or more portions of a prediction model 95 appear to adversely skew the predictive performance score 268.

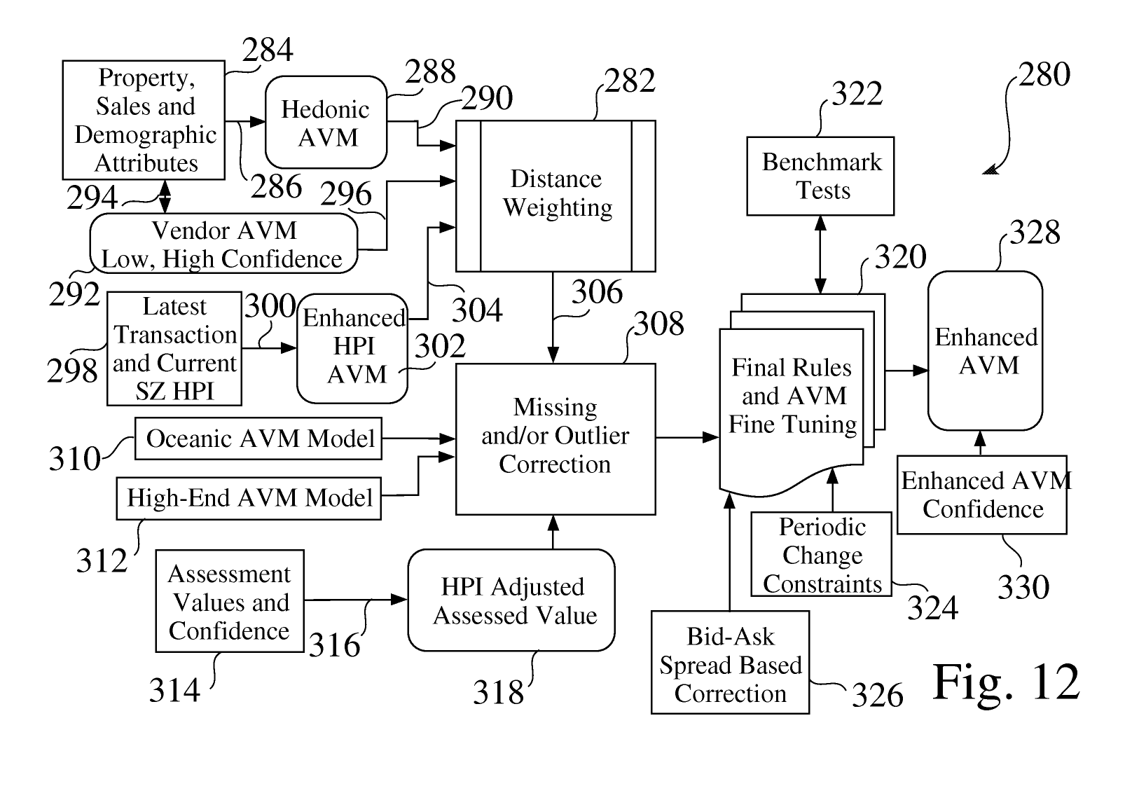

FIG. 12 is a schematic view of an exemplary embodiment of an enhanced automated value model system and process 280 for an enhanced targeted prediction system 20. As seen in FIG. 12, a number of different factors may preferably be used as input to a distance-weighting module 282. For example, a hedonic valuation model 288 may be applied to property 132, sales, and demographic attributes 284, wherein the results of the hedonic valuation model 288 are input to the distance-weighting module 282. As well, confidence ratings 292, e.g. ranging from low to high, may be applied to the distance weighting module 282, such as corresponding 294 to the property 132, sales, and demographic attributes 284. Furthermore, the latest transaction and a current enhanced housing price index 298 may be input 300 to the enhanced housing price index valuation model 302, which is then input 304 to the distance-weighting module 282.

The result from the distance weighting module 282 is output 306, and may preferably then be corrected, such as based on missing data, or due to data that differs significantly from clustered data 412 (FIG. 15), e.g. an outlier condition. Adjustments may also be made, such as but not limited to any of:
adjustment based on an oceanic valuation model 310;
high-end valuation model 312;
assessment values and/or confidence values 314, and housing price index adjustments 318 of assessed values.

For example, in some real estate markets 72a (FIG. 4), some properties 132 that are located in desirable locations, e.g. such as but not limited to oceanfront properties 132, or neighboring prestigious country clubs, the value and/or appreciation may be independent of other surrounding properties 132. Oceanic properties are defined as properties that fall within one mile of a coastline, and high-end properties can be defined as properties that fall into the 95th percentile of price per square foot in a given geography. In such a circumstance, an oceanic valuation model 310 may preferably weight the determined rating accordingly. Similarly, for high-end properties 132, e.g. such as but not limited to very expensive, exclusive, large, and/or historical properties 132, a high-end valuation model 312 may preferably weight the determined rating accordingly. These models are isolated from the larger AVM population and are estimated independently due to the idiosyncratic differences exhibited by these properties. This group of models, unlike the general AVM models, may preferably include as predictors bathrooms and lot size square footage and their corresponding quadratic terms.

Once weighting 282 and corrections 308 are made to the data, final rules and valuation model tuning 320 may preferably be performed, before arriving at the enhanced automated valuation model 328. Other factors may also be considered to create or to modify or update a valuation model 328, such as but not limited to any of benchmark testing 322, periodic change constraints 324, bid-ask spread based correction(s) 326, or any combination thereof. A confidence rating 330 may also be applied or assigned to the enhanced valuation model 328, such as based on past, current, or predicted performance of the enhanced valuation model 328.

As noted above, the enhanced targeting prediction system 20,e.g. 20a, may preferably provide ongoing performance monitoring and adjustment 116, such as on a periodic basis, e.g. such as but not limited to every 30 days. For example, FIG. 12 FIG. 13 is a schematic view 340 of exemplary performance monitoring for targeted marketing with a prediction list 112 through one or more channels 342, e.g. 342a-342e. A client CLNT, such as but not limited to a real estate agent CLNT, may have a ranked list of top leads, such as provided in hard copy, and/or displayed or otherwise delivered through one or more windows of a user interface 40 (FIG. 2).

Upon receipt of the prediction list 112, the agent CLNT may preferably contact potential customers CST, through one more channels 342, e.g. 342a-342e. For example, the agent CLNT may send mailings 344, send emails or text messages 346, make contact through social networks 348, e.g. Facebook, MySpace, LinkedIn, etc., phone calls 350, or by placing 352 advertising 352 that may preferably be targeted to potential customers CST.

Based on contact through one or more channels, which may preferably be targeted to potential customers CST that have been identified through the prediction list 112 as having an increased probability of proceeding to take a desired action, one or more of the contacted potential customers CST may initiate interest, such as through one or more of the channels 342. For example, a potential customer may visit a website 362, such as corresponding to the agent CLNT, or provided through the enhanced system 20. The entry to the website 362 may preferably be provided through a hyperlink, and the impression 364 of the visit, such as by navigating to a landing page at the website 362, may be logged and tracked. The performance of one or more of the channels 342 may thus be tracked, and the results may be input back to the prediction system 20, such as to track the performance of the prediction model 95 that was used to create the prediction list 112, and as desired, to update the prediction model 95, based on an analysis of the performance monitoring 116.

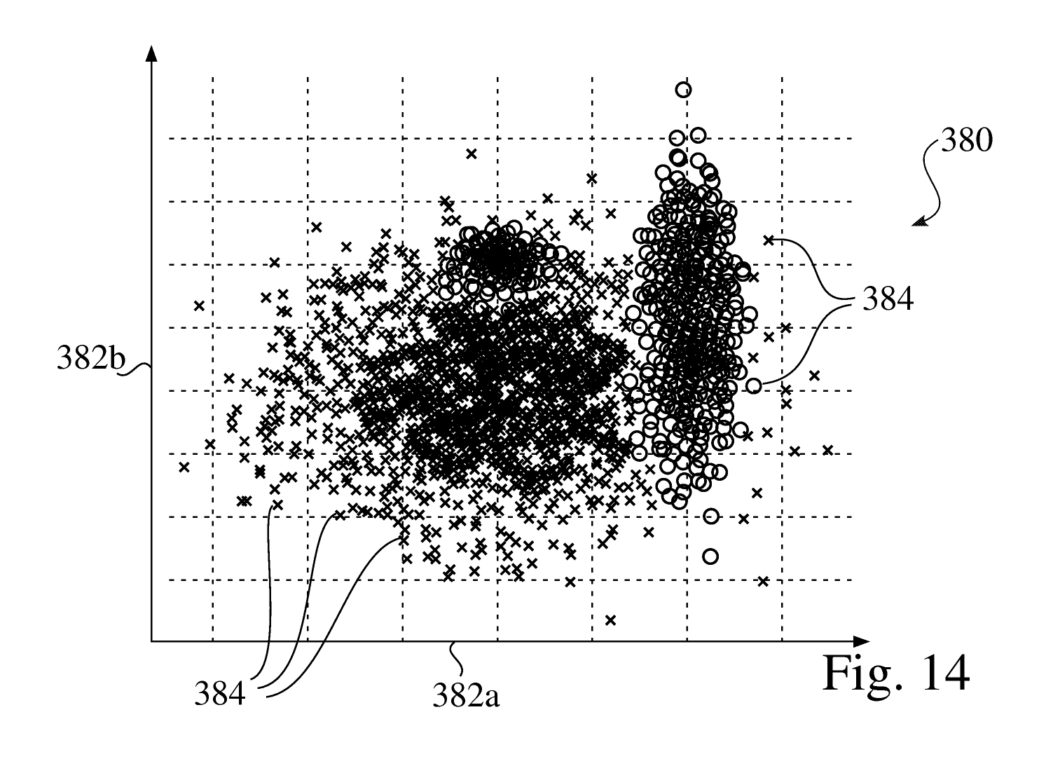

FIG. 14 is a chart 380 showing a population of data 82 for a plurality of assets 132, e.g. properties 132, wherein the assets 132 may be processed and analyzed, e.g. with respect to different attribute axes 382, e.g. 382a,382b, and wherein statistical clusters 412 (FIG. 15) may be formed with respect to one or more attributes 83. FIG. 15 is a detailed chart 410 showing statistical clusters 412 formed from a plurality of assets 132. For example, different attributes 382, e.g. 382a-382c, may preferably be shown for a population of data 82, yielding a plurality of data points 384. In the example seen in FIG. 15, a population of data 82 is shown with respect to appreciation 382a, holding period 382b, and selling frequency 382c. As seen in FIG. 14 and FIG. 15, the resultant data may be seen to produce a plurality of statistical clusters 412, e.g. 412a-412c, wherein groups of data points 384 may be determined to belong.

The enhanced prediction system 20 and prediction models 95 may preferably be based on a hybrid of Fuzzy K-Means clustering, logistic regression based training, and Support Vector Machines. Fuzzy K-Means clustering is an extension of K-Means or C-Means clustering techniques.

Traditional K-Means clustering discovers hard clusters, such that each data point 384, which can be represented as a vector, belongs strictly to only one cluster 412. In contrast, Fuzzy K-Means clustering is a statistically formalized method through which soft clusters 412 can be determined. With soft cluster methods, each vector can belong to multiple clusters 412, with varying probabilities.

Fuzzy C-means (FCM) clustering or Fuzzy-K-Means (FKM) clustering are methods by which a sample of data 82 can be divided into several clusters 412, wherein each data point 384 is probabilistically associated to each cluster 412, dependent on the vector properties of that data point 384. Within each cluster 412, there lies a theoretical cluster centroid 414, e.g. 414a (FIG. 15), which may preferably be considered to be the representative member of that cluster 412.

Since Fuzzy Clustering offers no boundaries on cluster size or cluster number, the system 20, such as step 130 (FIG. 6), evaluates the optimal association, by minimizing average cluster volume, while simultaneously maximizing cluster density. Further, the optimal cluster allocation may preferably also be scored, by determining the resultant multiplier, e.g. an income multiplier, of the dominant cluster. For example, in an enhanced prediction system 20 that is used for real estate 72a (FIG. 4), the income multiplier comprises a statistic that captures the proportional change in sales value by isolating on the dominant cluster 412, instead of the larger population 82 as a whole, which can be shown as:

$$IM = \frac{1}{CM} * \frac{CS}{TS} ; \qquad ( Equation 1 )$$

wherein:
IM represents the Income Multiplier, e.g. such as calculated at step 270 (FIG. 11);
CM represents the Cluster Mass or the ratio of cluster size to population size;
CS represents the property sales observed in the cluster 412; and
TS represents the property sales observed in the total population.

The Fuzzy K-Means clustering algorithm aims to optimize over the following objective function:

J_{q}(U,V)=Σⱼ₌₁^{N}Σᵢ₌₁^{K}(uᵢⱼ)^{q}d²(Xⱼ, Vᵢ); K≦N (Equation 2),

wherein:
U is the space of vector associations;
V is the space of cluster centroids; and
uᵢⱼ is the degree of association between vector Xⱼ and centroid Vᵢ, which is defined as:

$${u}_{ij} = \frac{{\vert \frac{1}{{d}^{2} ( {X}_{j} , {V}_{i} )} \vert}^{1 / ( q - 1 )}}{{\sum }_{k = 1}^{K} {\vert \frac{1}{{d}^{2} ( {X}_{j} , {V}_{k} )} \vert}^{1 / ( q - 1 )}} , \qquad ( Equation 3 )$$

wherein d is the weighted Euclidean distance metric: defined as

$$\begin{matrix}d ( p , q ) = d ( q , p ) \\ = \sqrt{\begin{matrix}{{w}_{1} ( {q}_{1} - {p}_{1} )}^{2} + {{w}_{2} ( {q}_{2} - {p}_{2} )}^{2} + … + \\ {{w}_{n} ( {q}_{n} - {p}_{n} )}^{2}\end{matrix}} \\ = \sqrt{{\sum }_{i = 1}^{n} {{w}_{i} ( {q}_{i} - {p}_{i} )}^{2}}\end{matrix} . \qquad ( Equation 4 )$$

Fuzzy clustering is carried out through an iterative optimization of the objective function shown above, with step-wise updates of membership uᵢⱼ and the cluster centroids Vᵢ. This iteration may preferably stop when the degree of membership converges to a value that is determined to be stable.

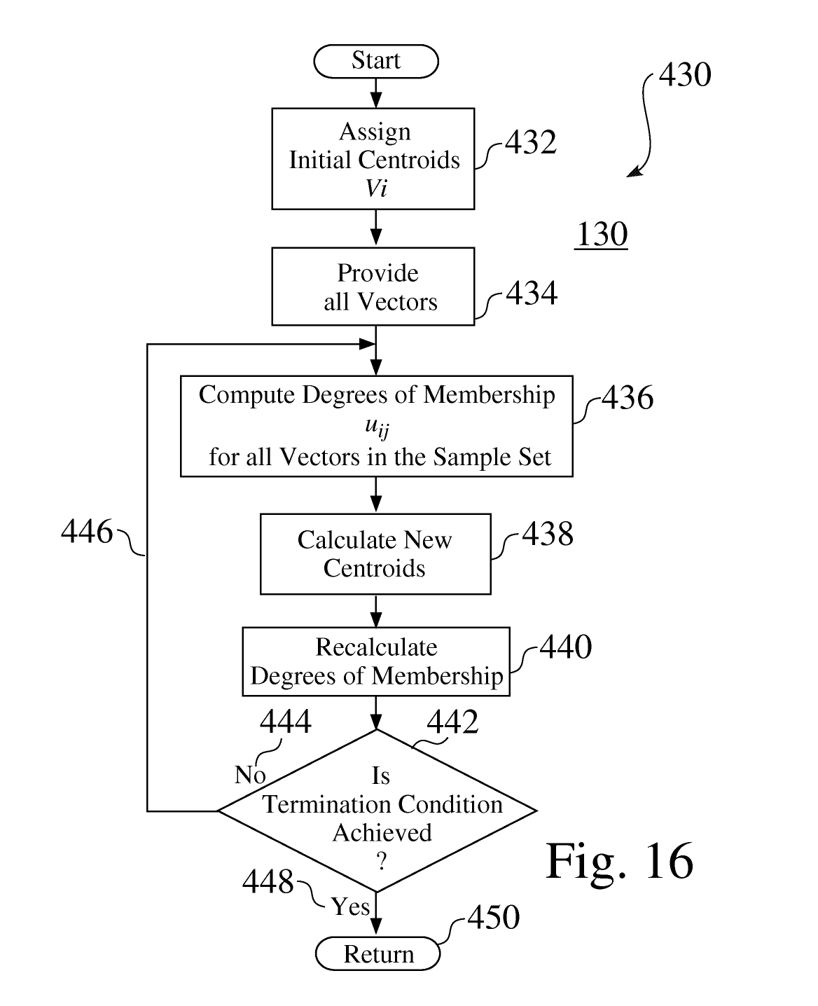

For example, FIG. 16 is a flowchart of an exemplary enhanced clustering process 430, such as performed during the building 130 (FIG. 6) of clusters 412 within the enhanced targeting prediction system 20. At step 432, the process 430 assigns initial centroids Vᵢ. Thereafter, for all vectors provided 434, the process 430 computes 436 the degrees of membership, uᵢⱼ, for all vectors in the sample set. At step 438, the process 430 calculates new centroids \hat{V}ₜ as:

$${\hat{V}}_{i} = \frac{{\sum }_{j = 1}^{N} {( {u}_{ij} )}^{q} {X}_{j}}{{\sum }_{j = 1}^{N} {( {u}_{ij} )}^{q}} . \qquad Equation 5$$

At step 440, the process 430 recalculates the degrees of membership as û\hat{uᵢⱼ}.

At this point in the process 430, if it is determined 442 that a termination condition has not 444 been achieved, the process returns 446, and reiterates steps 436 through 440. Once it is determined 442 that a termination condition has 448 been achieved, the process 430 stops and returns 450. In some embodiments of the process 430, the termination condition is given as:

maxᵢⱼ[|iᵢⱼ−\hat{uᵢⱼ}|]<ε; for a termination criterion ε.

The clustering results may preferably be evaluated by one or more of the following metrics:
Fuzzy Hyper-Volume;
average Fuzzy Cluster Density; and
the resultant Income Multiplier.

In some system embodiments 20, the clustering results may preferably be evaluated by all three of the metrics. The Fuzzy Hyper-Volume may preferably be calculated by the following formula:

$$\begin{matrix}{F}_{H V} = {\sum }_{i = 1}^{K} {\vert det ( {F}_{i} ) \vert}^{1 / 2} , & ( Equation 6 ) \\ where \text{:} & \\ {F}_{i} = \frac{{\sum }_{j = 1}^{N} h ( i \vert {X}_{j} ) ( {X}_{j} - {V}_{i} ) {( {X}_{j} - {V}_{i} )}^{T}}{{\sum }_{j = 1}^{N} h ( i \vert {X}_{j} )} , and & ( Equation 7 ) \\ H ( i \vert {X}_{j} ) = \frac{1 / {d}_{e}^{2} ( {X}_{i} , {V}_{i} )}{{\sum }_{k = 1}^{K} 1 / {d}_{e}^{2} ( {X}_{i} , {V}_{k} )} . & ( Equation 8 )\end{matrix}$$

The Fuzzy Cluster Density may preferably be calculated as:

$${D}_{PA} = \frac{1}{K} {\sum }_{i = 1}^{K} \frac{{S}_{i}}{{[ det ( {F}_{i} ) ]}^{1 / 2}} , \qquad ( Equation 9 )$$

where:

Sᵢ=Σⱼ₌₁^{N}uᵢⱼ ∀ Xⱼ ∈{Xⱼ: (Xᵢ−Vᵢ)Fᵢ⁻¹(Xⱼ−Vᵢ)<1} (Equation 10).

The Fuzzy C-means clustering 412 for a selected prediction model 95 may preferably be used in the back testing training period 92 (FIG. 5), to get the best centroids 414 (FIG. 15) to apply to testing 96. The prediction ratio or income multiplier 270 (FIG. 11), e.g. the multiplier of the determined top 20 percent of homes that become sales, over a random 20 percent of all homes in a sample, may preferably be used to measure the result of modeling.

In the generation of targeting lists, in addition to Fuzzy K-Means clustering, which returns memberships to various centroids, Some system embodiments 20 may also utilize logistic regression models. Logistic regression models are distinct from ordinary least squares regression models in that it is used to predict binary outcomes (such as sold/listed=1 or not=0) rather than continuous outcomes (such as property AVM). The resultant predictions generated from a logistic regression are thus the expected event value, which can be interpreted as the probability of an event occurring (such as the sale/listing of a property). The logistic function (i.e. log(p/1-p)) ensures that the predicted probabilities span the space of the linear predictors, as shown in Equation 11. The system 20 estimates the coefficients of logistic regression models by using maximum likelihood estimation (MLE) assuming the probability of our binary response variable is obtained by inverting the previous logit function.

$${log ( \frac{{p}_{i}}{1 - {p}_{i}} )}_{( ε ℝ )} = {{β}_{0} + {β}_{1} {X}_{1 , i} + {β}_{2} {X}_{2 , i}}_{( ε ℝ )} + … . \qquad ( Equation 11 )$$

During the generation 110 (FIG. 5) of the prediction list 112 with a chosen prediction model 95, Fuzzy C-means clustering may preferably be applied to a data segment that corresponds to a territory, e.g. 254, associated with a client CLNT, e.g. a territory that is customized for a specific client CLNT, to generate a list 112 of properties 132, based on their likelihood of being sold. The ranking of each member of the prediction list 112 that delivered to the client CLNT is typically linked to corresponding information, such as but not limited to any of property information, owner information, transaction information, loan data information, and/or other enhanced analytic information.

The enhanced prediction system 20 and process 10,80 may preferably input and use a wide variety of attributes, such as to predict one or more tagged home sale events for embodiments related to real estate 72a. For example, the enhanced methodologies may use any of hazard survival methodologies, life events data, tax information, transactions, property level data, other consumer behavior data, Cox regression information, or any combination thereof.

Furthermore, the ranked output 112 of the enhanced prediction system 20 and process 10,80 associated with real estate 72a may preferably be based on a prediction of one or more tagged home sale events, such as comprising any of predictions of listings, predictions of sales, or predictions of time to sales.

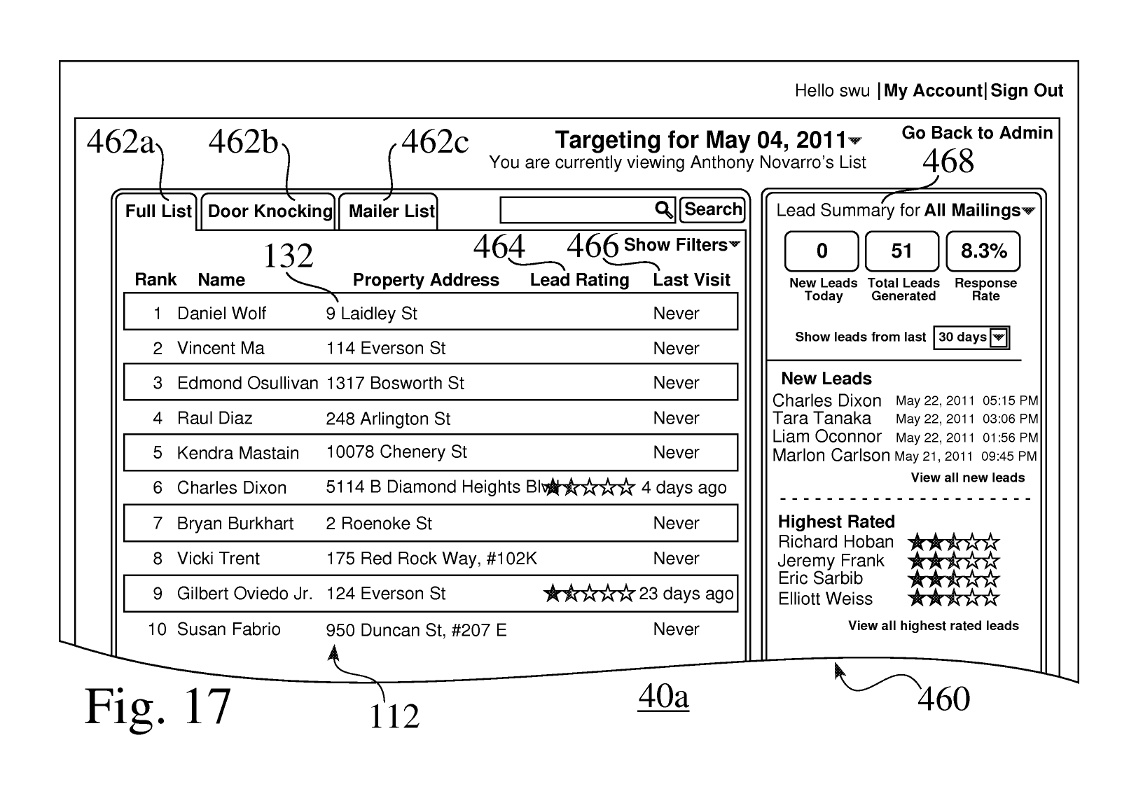

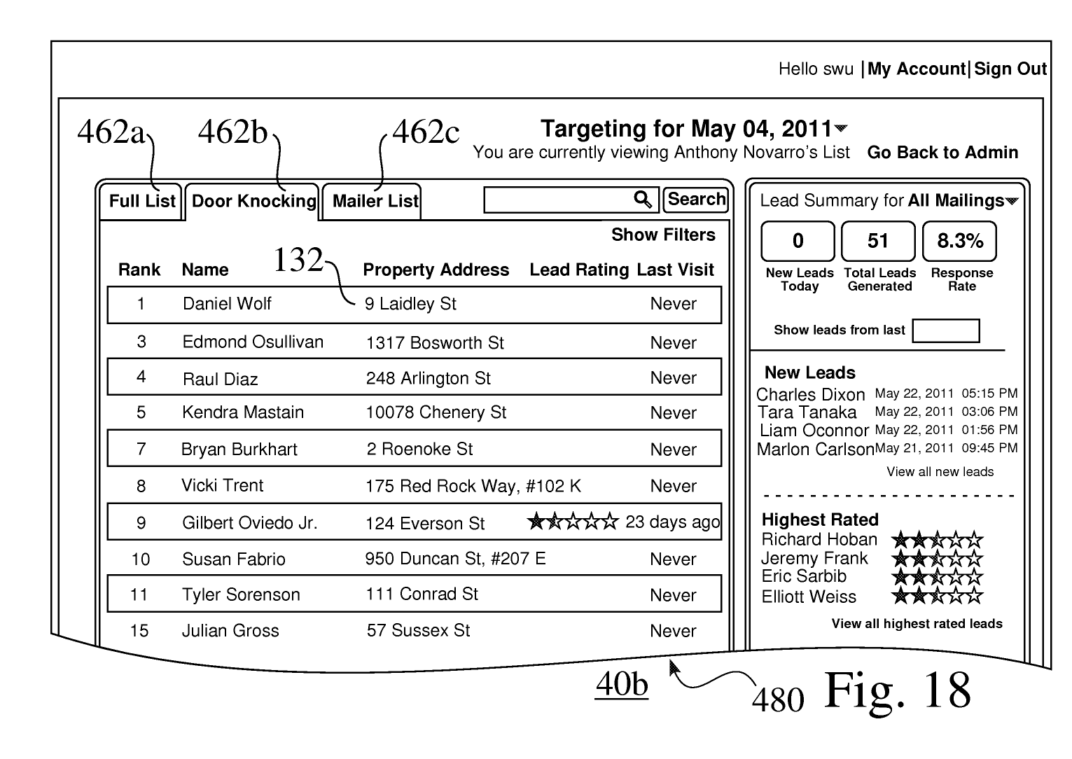

FIG. 17 shows an enhanced user interface 460 comprising an exemplary full listing 462a of enhanced targeting, such as displayed within an enhanced client interface 40. FIG. 18 shows 480 an exemplary door-knocking list 462b of enhanced targeting for a corresponding agent, such as displayed within an enhanced client interface 40.

For example, as seen in FIG. 17, the enhanced user interface 40a may preferably comprise selectable tabs 462, e.g. 462a-462c, such as to display any of a full list 462a of ranked information, a door-knocking list 462b, or a mailer list 462c. A lead rating 464 may also be displayed, such as but not limited to any of a numerical, alphabetical or graphic icon based rating for one or more potential customers CST within a client's territory, e.g. 254. A lead summary information 468 may also preferably be displayed within the enhanced interface 40, such as to display any of a number of new leads within a period, a number of total leads generated, a response rate, a listing of new leads, or a listing of the highest rated leads. The door knocking list 462b seen in FIG. 18 provides a complimentary view to the full list 462a, and may be used by the client CLNT to organize targeted marketing, such as through one or more channels 342 (FIG. 13).

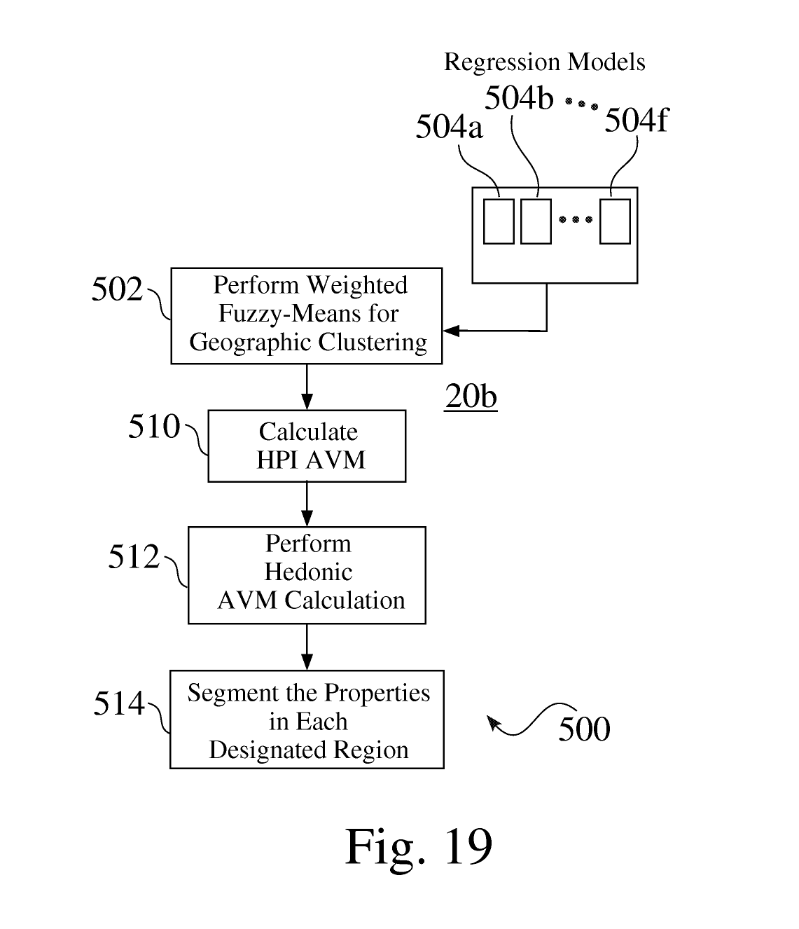

Enhanced Systems, Processes, and User Interfaces for Valuation Models and Price Indices Associated with a Population of Data. FIG. 19 is a flow chart of a system 20b and process 500 for property valuation. The enhanced marketing prediction system 20, e.g. 20b, and process 500 may preferably streamline a traditional residential property valuation process, with data-driven predictive modeling systems and processes that provide objective, consistent and fast valuation for each property 132.

The enhanced valuation model system 20b and process 500 may preferably be applied to a wide variety of business applications that concern property valuation, such as but not limited to any of:
real estate listings;
real estate transactions;
home loan originations; and/or
mortgage based securities.

The enhanced valuation system 20b and process 500 may preferably be used by one or more entities, such as but not limited to any of buyers, borrowers, underwriters, sellers, lenders, and/or investors.

As seen at step 502 in FIG. 19, the valuation process 500 typically begins by performing weight fuzzy-means calculations on a population of data 82, to determine geographic clusters 412 (FIG. 15). The process then calculates 510 valuations, based upon one or more housing price indices, e.g. HPI 298 (FIG. 12). At step 512, the process 500 performs hedonic valuation model (AVM) calculations on the data, such as also seen in step 288 in FIG. 12. In step 514, the process 500 segments the properties 132 in each designated region, such as based on any of the enhanced calculated valuations, or by price buckets. For example, the segmentation may preferably differentiate between any of:
normal listing versus foreclosure;
distressed listings and normal sales versus foreclosure/distressed sales.

As well, the hedonic regressions used in step 512 may preferably be nested, and may preferably be calibrated within the property clusters 412 that are derived from step 502.

In some embodiments, the process 500 is dynamically weighted, using a set of semi-parametric regression models that are based on Fuzzy C-means techniques, to estimate the housing prices of a large number of properties 132, e.g. such as for up to 80 million nation wide properties 132. The enhanced valuation models, e.g. 302 (FIG. 12) may preferably be created using weighted clustering and nested hedonic regression techniques.

The fuzzy clustering step 502 is first applied to create geographic clusters 412 (FIG. 15), at various micro and macro geographical levels 194 (FIG. 7, FIG. 8), such as based on but not limited to any of census tract 144, city 140, county 146, and state 148, upon which a set of nested enhanced regression models 504, e.g. 504a-504f, are performed.

For real estate applications, the enhanced regression models 504 may preferably factor variables that are related to property characteristics, such as any of financial characteristics, geographic characteristics, demographic characteristics, or any combination thereof. For example, such characteristics may preferably comprise any of:
tax information;
property transaction history, e.g. comparable sales, listing prices;
neighborhood data, e.g. median family income, school ratings, safety ratings;
property information, e.g. assessment prices, monthly rents; and/or
property structural information, e.g. lot size, square footage, number of bedrooms, number of bathrooms, etc.

The plurality of regression models 504, e.g. 504a-504f may preferably employ different variable levels in the interactions at different geographic clusters, such as to empirically determine which of the regression models 504 achieve an optimal goodness-of-fit.

The valuations calculated at step 510 may further be fine-tuned using other heuristic information, such as to keep the estimated valuations current, e.g. by using the most recent real estate transaction data.

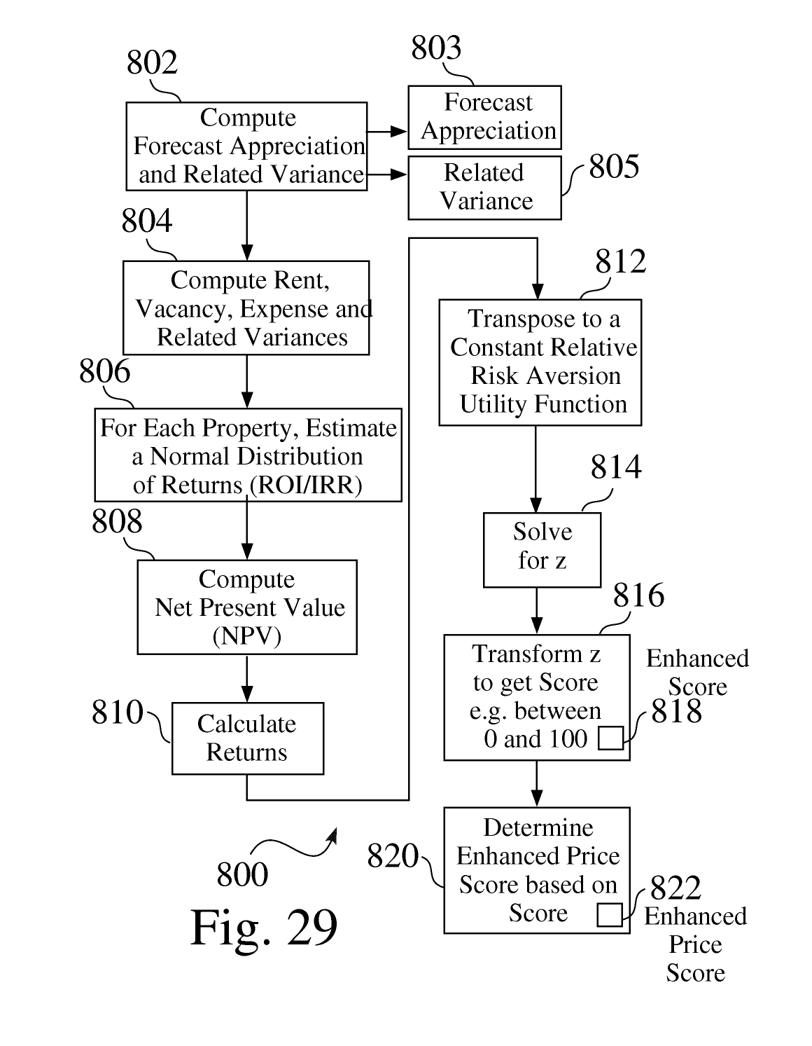

The process 500 may preferably weight one or more of the housing price valuation metrics, such as by their spread with respect to any or both of recent listings and sales prices. For example, the process may preferably weight any of:
the HPI AVM obtained in step 510;
the hedonic AVM obtained in step 512; and/or
the enhanced SmartZip™ Home Score 818 (FIG. 29).

In some system embodiments, the inputs to the process 500, e.g. represented as X, may comprise any of:
home square footage;
number of bedrooms;
number of bathrooms;
months from the last transaction;
school rating; and/or
safety rating.

Based on the inputs X, it is desirable to predict the base price y of a property 132. Each regression represents a partitioned space of all joint predictor variable values into disjoint regions, which may be shown as:

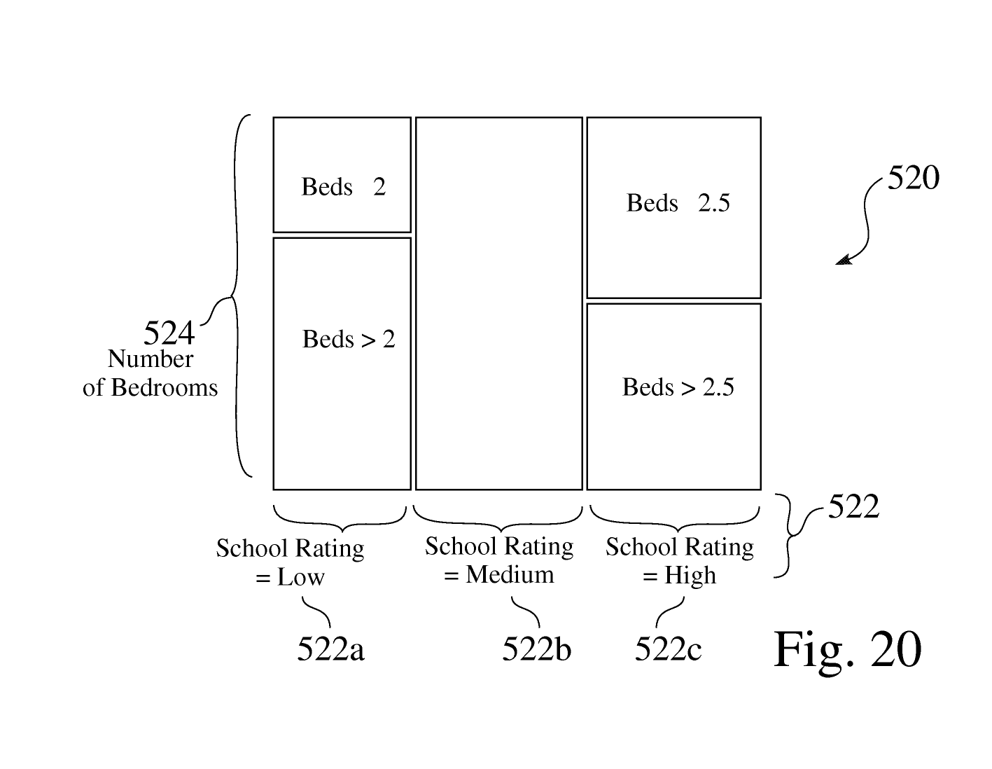

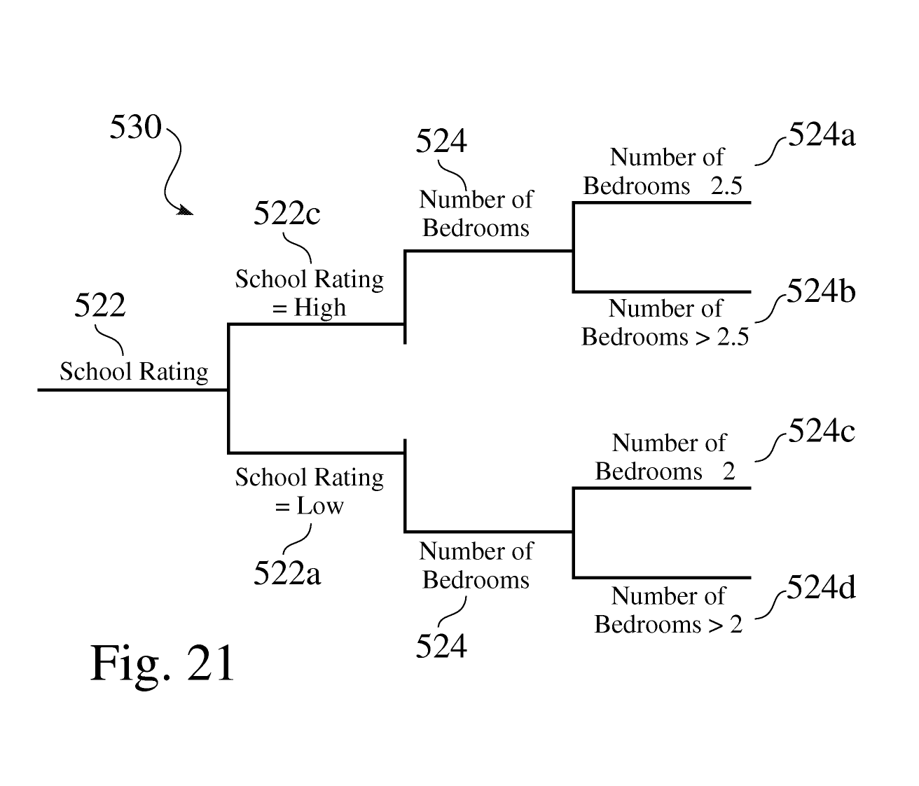

Rⱼ, ∀ j ∈ {1,2, . . . . , J} (Equation 12),

wherein J may represent the terminal nodes of a regression tree. For example, FIG. 20 is a schematic chart 520 that shows a relationship between a school rating 522 for neighboring residential properties 132 having different numbers of bedrooms 524, which can alternately be demonstrated by the disjoint space divided by the integrations of the categorical variables within a regression tree 530. FIG. 21 is an exemplary regression tree 530 associated with school ratings 522 and the number of bedrooms 524 for different groups of neighboring residential properties 132. The regression tree 530 seen in FIG. 21 may be expressed as:

Y(x, θ)=Σⱼ₌₁^{j}γⱼ1(x∈Rⱼ) (Equation 13),

wherein:

x ∈ Rⱼ→f(x)=γⱼ (Equation 14),

and

Θ={Rⱼ, γⱼ} (Equation 15),

wherein J represents the number of leaf nodes.

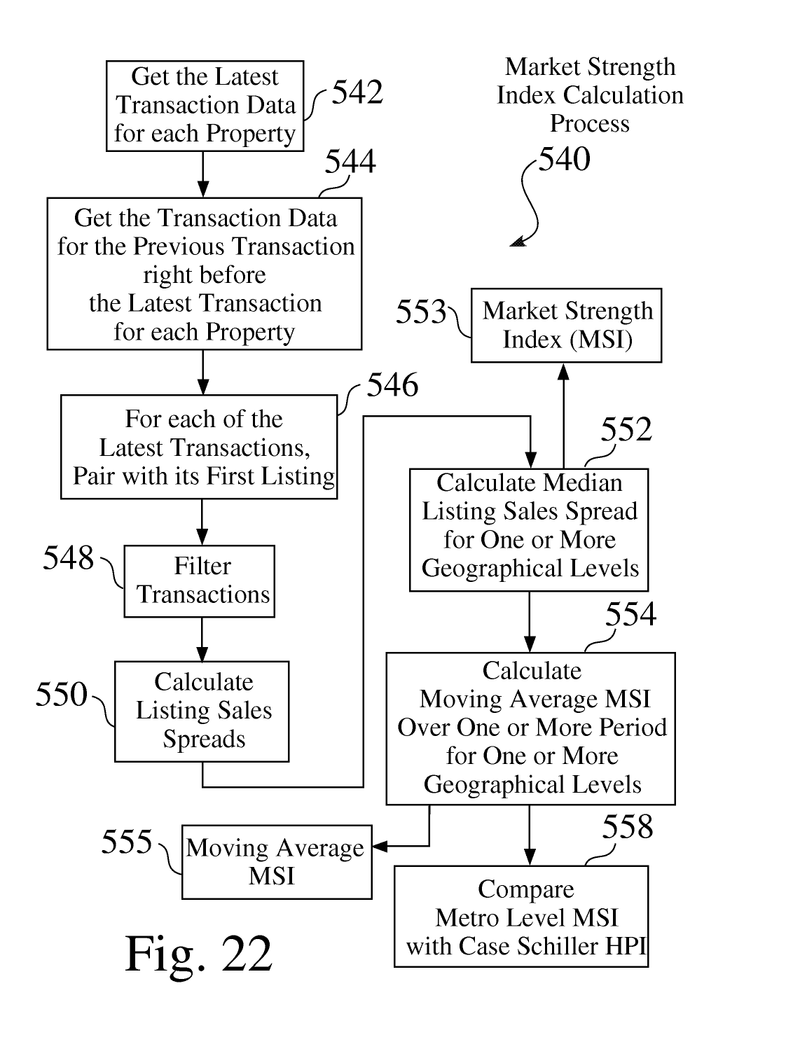

FIG. 22 is a flowchart of an exemplary process 540 for determining an enhanced market strength index 553. At step 542, the process 540 receives, queries a database, or otherwise acquires information regarding the latest transaction for each property 132, such as acquired through deed information or other official document, e.g. through a county office or an assessor's office.

At step 544, the process 540 receives, queries a database, or otherwise acquires information regarding the previous transaction right before the latest transaction for each property 132. At step 546, for each of the latest transactions, the process pairs the transaction with its first listing, wherein the paired listing is the first listing after the previous transaction and before the latest transaction.

The process 540 then filters 548 the transactions, such as to prevent consideration of any of:
foreclosures;
distressed properties 132;
inter family transactions or listings; or
listings more than 1 year away.

The process 540 then calculates 550 the listings sales spreads for each transaction, which is shown as:

listing sales spread=100*(sales price−initial listing price)/sales price. (Equation 16).

The process 540 then calculates 552 the market strength index (MSI) 553 at one or more geographical levels 194, such as based on but not limited to one or more of census tract 142, zip code 144, place/city 140, county 146, CBSA (FIG. 8), state 148, and/or nation 154. The calculated market strength index 553 is the median listing sales spread for each of the calculated geographical levels 194.

The process 540 may also calculate 554 one or more moving average MSIs 555 over one or more periods, e.g. 60 days and/or 90 days, for one or more geographical levels 194. For example, for a 60 day period, the moving average MSI is calculated as the sum of listing sales spread in 60 days, divided by number of listing sales pairs in the 60 days, for each of the one or more geographical levels 194.

At step 558, the process 540 may preferably compare 558 the metro level MSI 553 to the Case Schiller housing price index (HPI), such as to compare and correlate between the two results.

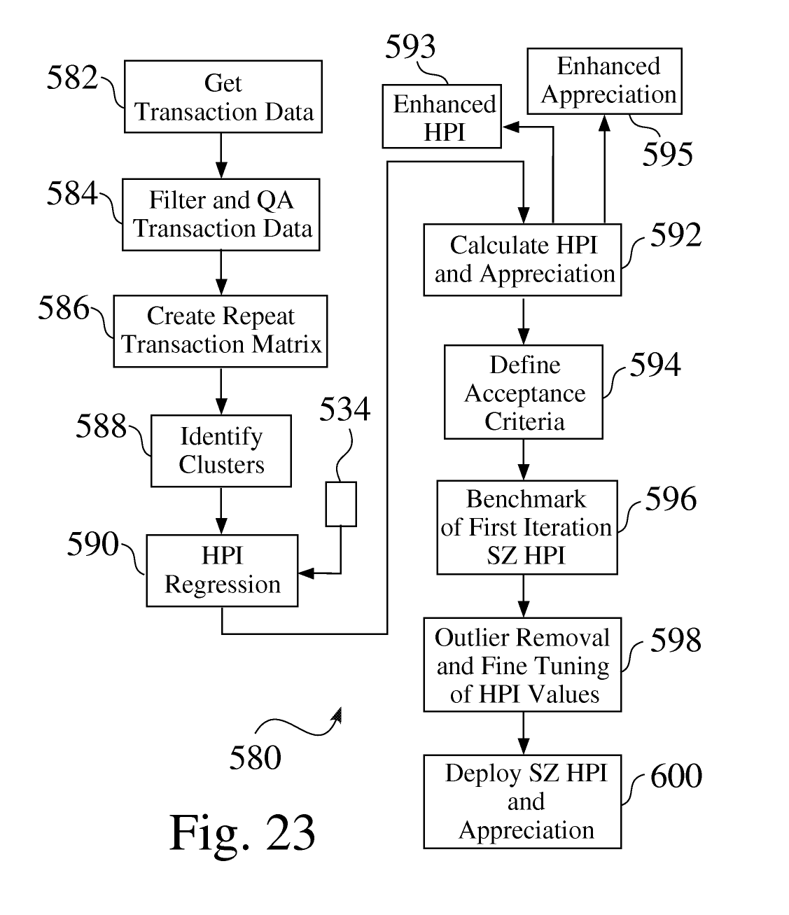

System and Process for Calculating Neighborhood Price Index based on Weighted Fuzzy Clustering. FIG. 23 is a flowchart of an exemplary process 580 to determine an enhanced housing price index 593 and predicted appreciation 595 for one or more properties 132. The enhanced housing price index 593 may preferably be performed on a wide variety of populations of data 82, such as at a metro level, as well as at a neighborhood level.

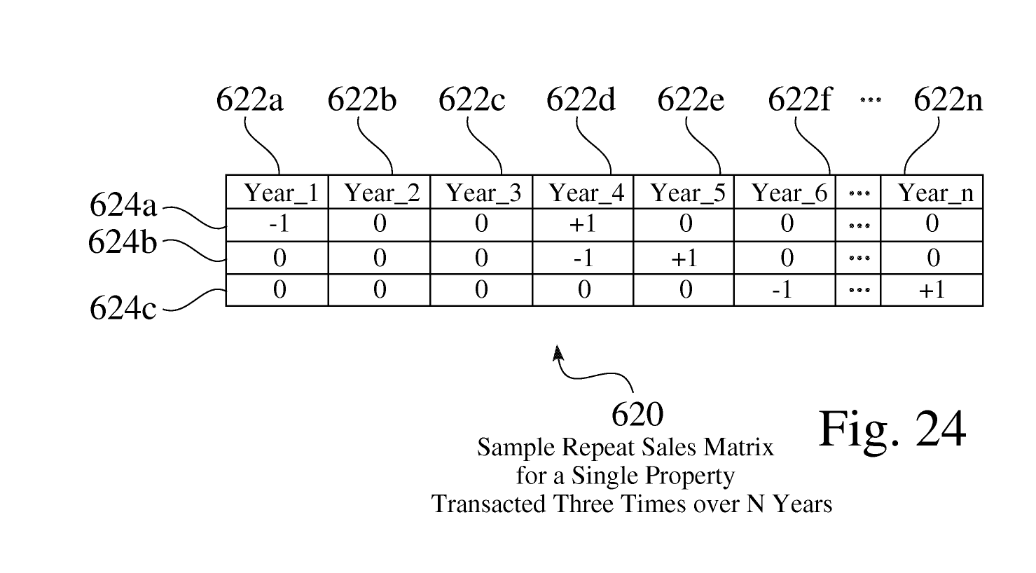

At step 582, the process 580 inputs transaction data, e.g. date and amount, for a population of data 82, such as at but not limited to a tract level 142 (FIG. 7). The transaction data is then filtered 584, such as by analyzing the statistical quality of the input transaction data. At step 586, repeat transaction matrices 620 (FIG. 24) are created for each of the properties 132 in the data sample. At step 588, the clusters 412 in the transaction data are identified. The process then runs 590 one or more enhanced regression models 534 on the clustered data, and then calculates 592 the enhanced housing price index (HPI) 593 and appreciation 595 values. At step 594, the process 580 defines acceptance criteria for the properties 132, such as but not limited to:
relative appreciation scores 595, e.g. below average, average, and above average; and/or
relative overall scores 818 (FIG. 29), e.g. an investment rating that varies between 0 and 100.

At step 596, the process 580 may preferably calculate benchmark levels, such as for the first iteration 592 of the enhanced housing price index (HPI) 593 and appreciation 595 values. The benchmarking step 596 may preferably be performed with any of the actual sales history of the properties 132, by comparison to Federal Household Finance Agency (FHFA) data, and/or by comparison to Standard & Poor (S&P) Case-Schiller indices, such as comprising any of:
a national home price index;
a corresponding 20-city composite index;
a corresponding 10-city composite index; and/or
a corresponding twenty metro area index.

At step 598, the process 580 may preferably provide removal of outliers, e.g. from the clusters 412 that were identified at step 588, and may provide fine tuning of the enhanced home price index (HPI) values 593. At step 600, the process 600 outputs, stores, or otherwise deploys the resultant enhanced HPI values 593 and appreciation values 595.

The step 588 of identifying statistical clusters 412 may preferably comprise quasi-clustering, such as to aggregate tract level data to a sufficient size for subsequent step 590, wherein one or more quantile regression models 534 are run to produce annualized price appreciation values. These annual price numbers are then converted to an indexed series, which tracks home prices through time.

The quantile regression step 590 returns increasingly accurate parameter estimates as the sample size grows. Conversely, as the sample size decreases, the resultant parameter estimates may be returned with decreasing confidence, such as measured by standard error. Therefore, to ensure the accuracy of the results, the process may define a minimum tract mass threshold. For tracts that do not contain an adequate number of properties 132 to exceed this threshold, the tracts may preferably be quasi-clustered 588 with neighboring tracts.

The step of quasi-clustering 588 begins by first calculating the Euclidean distance between the representative member of the target cluster 412 and the representative members of all other clusters 412. A representative member is defined as a property 132 that holds mean levels for the measured attributes. In some current embodiments, the measured attributes comprise:
latitude;
longitude;
median income; and
2000 census rent.

The Euclidean distance formula for n-dimensional vectors p and q is given as:

$$\begin{matrix}d ( p , q ) = d ( q , p ) \\ = \sqrt{\begin{matrix}{( {q}_{1} - {p}_{1} )}^{2} + {( {q}_{2} - {p}_{2} )}^{2} + … + \\ {( {q}_{n} - {p}_{n} )}^{2}\end{matrix}} \\ = \sqrt{{\sum }_{i = 1}^{n} {( {q}_{i} - {p}_{i} )}^{2}}\end{matrix} . \qquad ( Equation 17 )$$

Once the inter-tract distances have been calculated for a given tract, the source tract with the minimum distance is associated with the target census tract, e.g. 142 (FIG. 7). Next, the tract level property count is updated, to include the newly associated tract, i.e. the number of properties 132, and the new total is compared against the minimum threshold. If this aggregated tract still fails to exceed the minimum tract mass, the next lowest distance tract, e.g. the next neighboring group of properties 132, is aggregated to the target. This process continues, until either the minimum threshold has been exceeded, or a maximum determined number of tracts, e.g. such as but not limited to ten tracts, have been aggregated to the target.

Once the set of tracts have achieved the minimum tract mass, tract-level appreciation values may preferably be calculated through the use of the quantile regression procedure 590.

An explanatory variable used in the quantile regression step 590 is a repeat sales matrix 620 (FIG. 24) that captures the sales and/or purchases of properties over time. FIG. 24 shows an exemplary repeat sales matrix 620 for a single property 132, wherein each column 622, e.g. 622a-622n, represents each period, e.g. each year, in the span of the analysis. Each row 624, e.g. 624a-624c, in the matrix 620 represents a single transaction over a property 132, and designates the purchase of a home with a −1 and a sale with a +1.

Thus, when a homeowner first buys a property 132, a −1 is entered into the corresponding year column, and similarly, when that same homeowner sells the property 132, a +1 is entered into the appropriate year column. If a property 132 is traded multiple times, over the time span being analyzed, multiple rows 624 are entered into the repeat sales matrix 620 against the property in question. In the years in which the property 132 is neither bought nor sold a zero is entered into the remaining year columns.

For example, in the exemplary repeat sales matrix 620 seen in FIG. 22 FIG. 24, a first homeowner bought the house 132 at Year_{—}1, as seen at row 624a and column 622a. The first owner sold the house 132 to a second homeowner at Year_{—}4, as seen in rows 624a, 624b and column 622d. The second owner sold the house 132 at Year_{—}5, as seen in row 624b and column 622e, wherein the house 132 was purchased at Year_{—}6 by a third homeowner, as seen in row 624c and column 622f.

For each repeat sales matrix 620, a corresponding annual appreciation column vector can be constructed, wherein each row represents the logarithm of annualized appreciation observed over the time period between the purchase and sale of a property 132, wherein this appreciation corresponds to the correct row 624 of the matching repeat sales matrix 620. The annualized appreciation is calculated as:

$$appr = {( \frac{{P}_{2}}{{P}_{1}} )}^{1 / ( {t}_{2} - {t}_{1} )} , where {t}_{2} > {t}_{1} . \qquad ( Equation 18 )$$

wherein appr represents the annualized appreciation and Pₓ is the price at time tₓ.

Once a repeat sales matrix 590 and a matching log annual appreciation vector 588 have been constructed, the quantile regression 590 can be run. The repeat sales matrix 620 captures the explanatory variables and/or the annual dummy variables, while the appreciation vector 588 acts as an explained variable.

In the quantile regression model, the objective function to be minimized is:

$${ }_{ u}^{min} E [ {ρ}_{τ} ( Y - f ( x , β ) ) ] = { }_{ u}^{min} ( τ - 1 ) {\int }_{- ∞}^{u} ( y - f ( x , β ) ) d {F}_{Y} ( y ) + {\int }_{u}^{∞} ( y - f ( x , β ) ) d {F}_{Y} ( y ) , \qquad ( Equation 19 )$$

wherein

ρ_{τ}(y)=y(τ−1(y<0) (Equation 20),

and l represents the indicator function.

In this model, Y is the explained variable, f(x,β) is the model form where x defines the explanatory variables, and β represents the corresponding coefficients. For the enhanced HPI calculation 592, a linear model form may preferably be shown as:

log(appr)=(year₁*β₁)+(year₂*β₂)+ . . . (yearₙ*βₙ) (Equation 21).

While an ordinary least squares regression model minimizes a sum of squared residuals, the quantile regression 590 minimizes the expected value of a tilted absolute value function for a given quantile, defined by t.

The quantile regression returns \hat{β}, which comprises the set of coefficient estimates for the dummy variable used as an explanatory variable.

Given \hat{β} and the corresponding dummy values, which designate transaction dates, the annualized appreciation 592 can be calculated as:

appr=exp{(year₁*\hat{β}₁)+(year₂*\hat{β}₂)+ . . . (yearₙ*\hat{β}ₙ)} (Equation 22).

Once the quantile regression results 590 are returned, such as for a given base year, the index value for a non-base year can be calculated, by using the base year and target years as transaction dates, as inputs into the above model form. The calculated appreciation 595 can then be used to inflate or deflate the base year index as necessary, wherein the base year index may typically be set at a defined value, e.g. 100.

Enhanced User Interfaces for Ratings, Comparable Properties, Estimated Values and Estimated Appreciation. The enhanced prediction system 20 may readily be used to distribute and display a wide variety of information through the client interface 40, such as based on the intended recipient CLNT, such as but not limited to any of an agent, a home owner, a prospective buyer, a loan officer, or an investor.

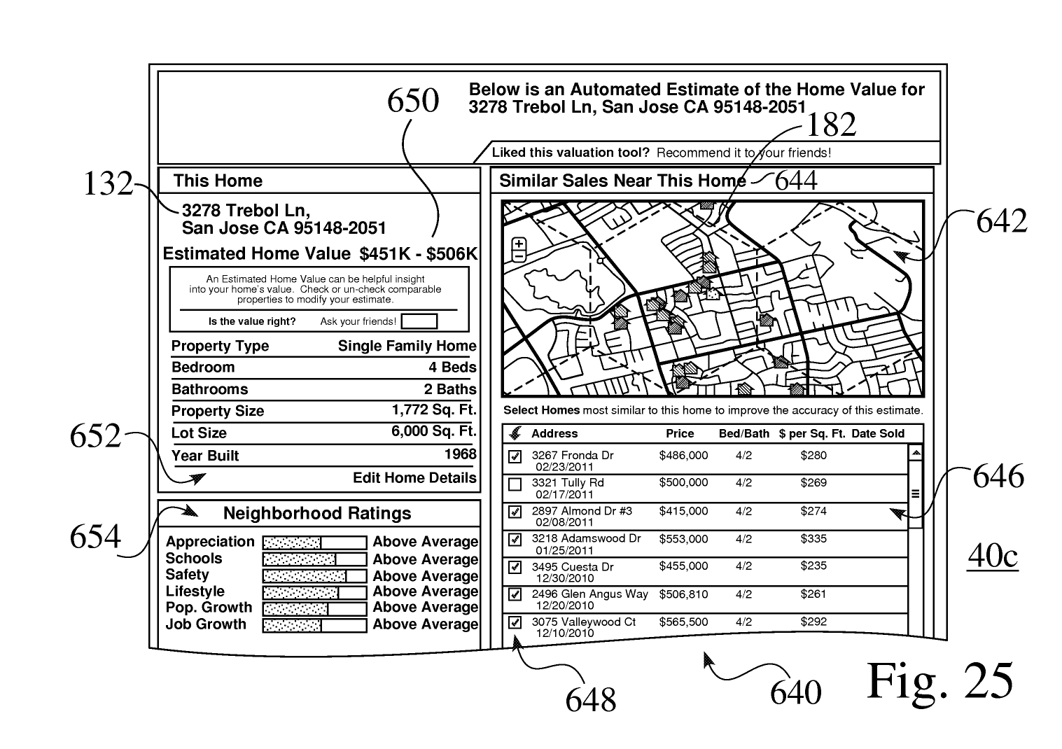

For example, FIG. 25 is a schematic view 640 of an exemplary enhanced user interface 40c for displaying estimated valuation parameters of an asset, e.g. a residential property 132. Within the exemplary user interface, a viewer, e.g. such as a user USR, client CLNT, or customer CST, may access a wide variety of information in regard to one or more properties 132. As seen in FIG. 25, the enhanced estimated value 650 of a property 132 is readily determined and displayed, and may preferably include a range of estimated value, which in this example is from $451,000 to $506,000. The specific information 652 related to the property 132 may also readily be displayed, such as but not limited to any of property type, number of bedrooms, number of bathrooms, property size, lot size, and the year built. The user interface 40c may also display neighborhood ratings 654, such as but not limited to an appreciation rating, a schools rating, a safety rating, a lifestyle rating, a population growth rating, and a job growth rating.

The enhanced user interface 40, such as the user interface 40c seen in FIG. 25, may further display a map 642 associated with any of the property 132, the neighborhood, other comparable properties 132 in the area, and/or other boundaries, such as but not limited to any of cities, counties, tracts, or territories 254. The exemplary user interface seen in FIG. 25 further comprises a list 646 of similar properties 132 that have been sold in the area, which may preferably be selected or deselected 648 by the viewer, such as to update the estimated value 650 of the displayed property 132 based on other neighboring properties 132 that the viewer deems to be most similar.

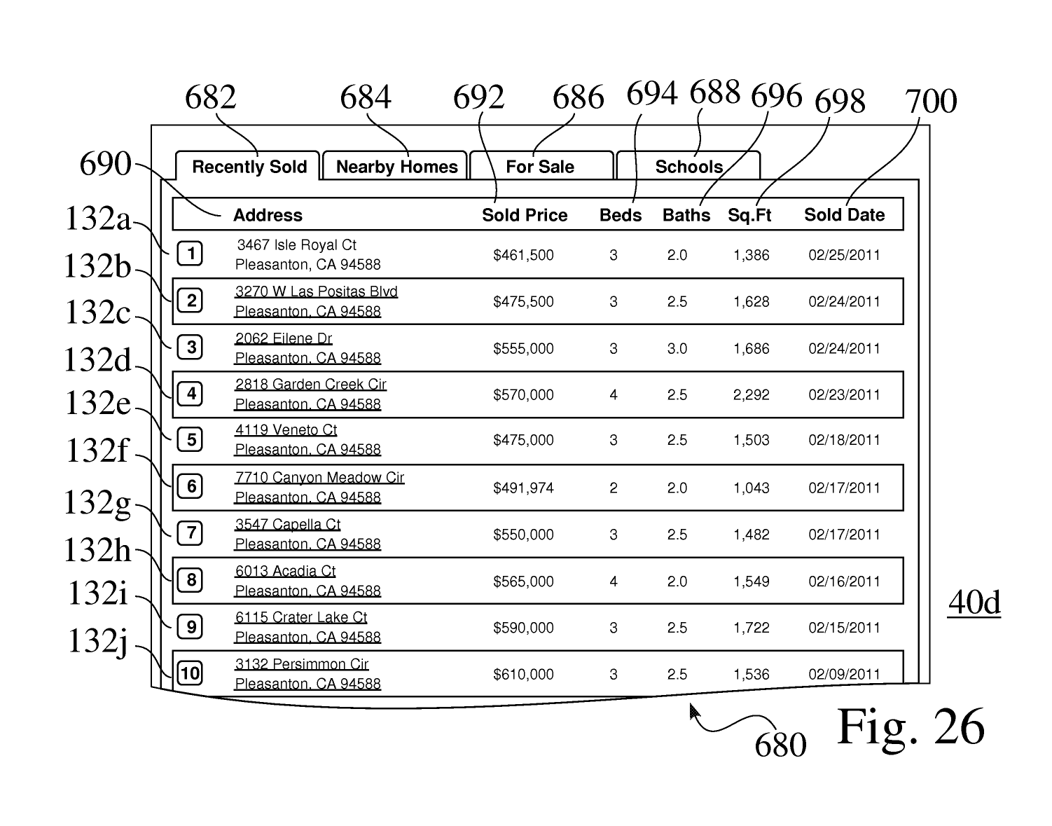

FIG. 26 is a schematic view 680 of an exemplary enhanced user interface 40d for displaying sales and asset information for comparable properties 132 in relation a property 132, e.g. a residential property 132a. As seen in FIG. 26, a list of comparable properties 132b-132j that have been sold recently 682 are displayed, wherein one or more attributes of the properties 132 may be provided, such but not limited to any of property address 690, sold price 692, number of beds 694, number of bathrooms 696, square feet of building 698, and sold date 700. As well, alternate list tabs may also be provided, wherein the viewer may readily access further information, such as but not limited to any of nearby homes 684, properties 132 that are currently listed for sale 686, and/or corresponding school information 688.

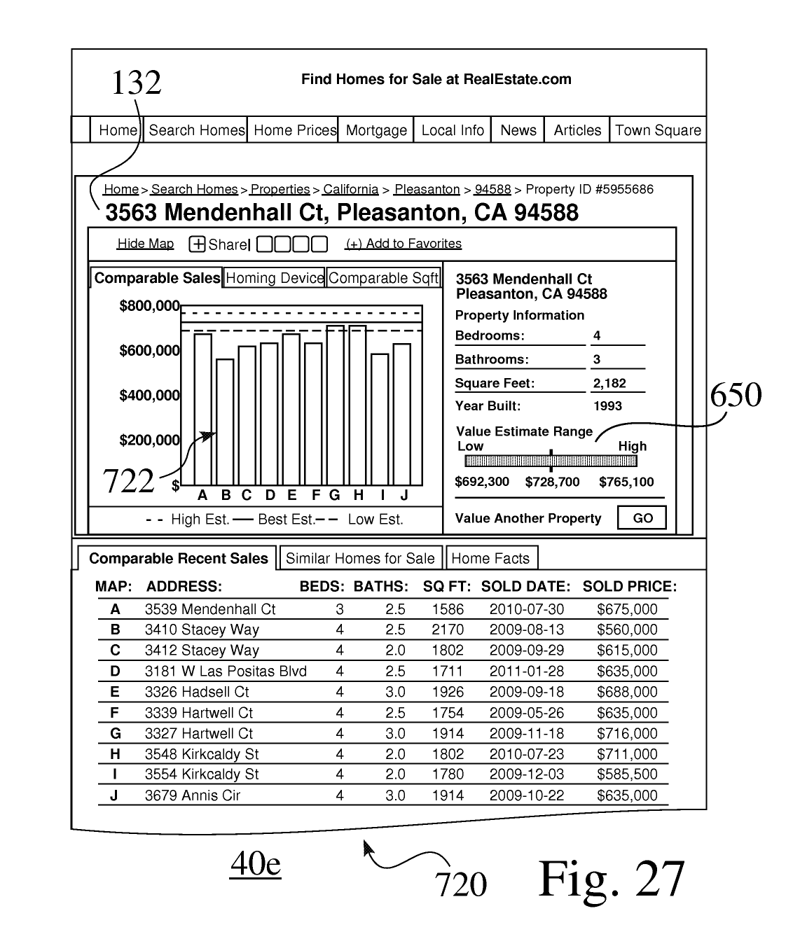

FIG. 27 shows detailed asset information 720, in addition to statistical information and a list of sales and asset information for comparable assets 132 within an exemplary enhanced user interface 40e. Within the exemplary user interface 40e, a viewer, e.g. such as a user USR, client CLNT, or customer CST, may access a wide variety of information in regard to one or more properties 132. As seen in FIG. 27, the enhanced estimated value 650 of a property 132 is readily determined and displayed, and may preferably include a range of estimated value, which in this example is from a low estimated value $692,300 to a high estimated value of $765,100, with a best estimated value of $728,700. The specific information related to the property 132 may also readily be displayed, such as but not limited to any of property type, number of bedrooms, number of bathrooms, property size, lot size, and the year built. The user interface 40, e.g. 40e, may also display comparable recent sales, similar home for sale, and home facts. The exemplary user interface 40e seen in FIG. 27 also comprises a detailed display 722 of sold price and/or estimated values for comparable properties, with tabbed access to other information that may be of interest to the viewer.

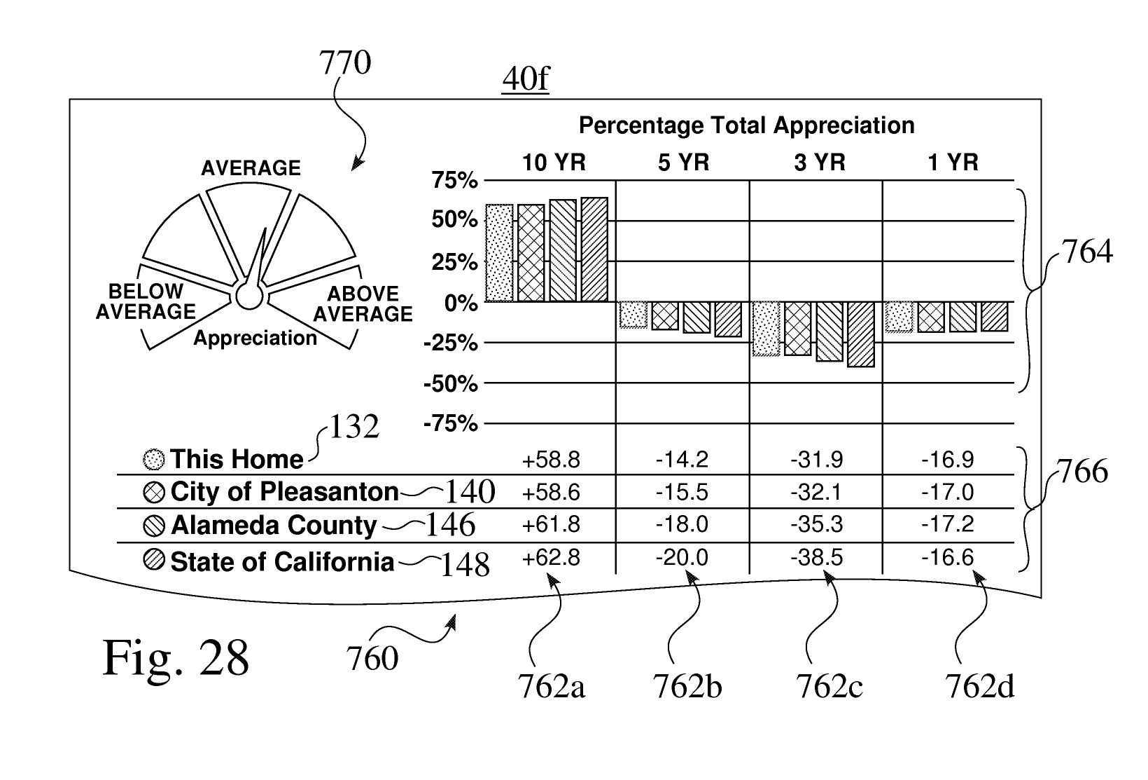

FIG. 28 is a display of enhanced neighborhood price index information 760 within an exemplary enhanced user interface 40f. As seen in FIG. 28, enhanced estimated appreciation values 762, e.g. 762a-762d, are provided through the user interface 40f, such as pertaining to a property 132, as well as the city 140, the county 146, and the state 148 where the property 132 is located. The exemplary estimated appreciation 762 seen in FIG. 28 comprises estimates of ten year appreciation 762a, five year appreciation 762b, three year appreciation 762c, and one year appreciation 762. The estimated appreciations 762 seen in FIG. 28 are shown both as numerical values 766, as well as in a graphic form 764, e.g. bar graphs 764.

As also seen in FIG. 28, the enhanced user interface 40, e.g. 40f, may comprise a graphic indication 770, e.g. a gauge, of one or more of the estimated appreciation values, wherein a viewer, e.g. an agent CLNT or a customer CST, may readily view and comprehend the relative appreciation values. The exemplary enhanced interface 40f seen FIG. 28 therefore provides a comprehensive display of the enhanced neighborhood price indices, such as from a metro level down to a neighborhood level, wherein the enhanced home price index is based on the comprehensive statistical analysis discussed above, and is sustainable over a population of data 82.

Enhanced Systems, Processes, and User Interfaces for Scoring Assets Associated with a Population of Data. The enhanced prediction system 20, such as seen in FIG. 2, may readily be used to implemented an enhanced processes for scoring assets, e.g. real estate assets, such as but not limited to residential properties and markets.

For example, FIG. 29 is a flowchart of an enhanced process 800 for determining home and investor scores 818, such as implemented with an enhanced system 20c. At step 802, the process 800 computes a forecast appreciation 803 and the related variance 805 for one or more properties 132. At step 804, the process 800 computes any of rent, vacancy, or expenses for the properties 132, along with related variances. At step 806, for each property 132, the process 800 estimates a normal distribution of returns (ROI/IRR). Within step 806, the process may preferably run a plurality of statistical scenarios, e.g. 25 scenarios, related to the forecast appreciation 803, the forecast rent, vacancy, or expenses 804, and related variances, to arrive at a forecast normal distribution.

The process the computes 808 the net present value (NPV) for each of the properties 132. Step 808 may further comprise a discount rate that is based on the intended investment strategy. For example, an investment strategy that is based on growth may have a relatively low discount, such as based on the impatience of the investment, while an investment strategy that is based on income may have a relatively high corresponding discount, as the investment is considered to be more patient.

At step 810, the exemplary process 800 seen in FIG. 29 computes the projected returns for the properties 132, wherein the return is equal to the results of step 808, i.e. the net present value (NPV), divided by the equity. At step 812, the process 800 transposes the output of step 810, by taking the log of the constant relative risk aversion utility function, which controls the risk tolerance, wherein an investment that is based on income has a relatively low risk tolerance, while an investment strategy that is based on growth has a relatively higher risk tolerance.

At step 814, the process 800 solves for z in the equation utility (R_{state}−z)=utility (comparable asset, e.g. treasury). At step 816, the process 800 transforms z that was calculated in step 814, to output an enhanced score 818 for the investment, e.g. a relative score 818 between 0 and 100, as shown:

score=lower_bound+cdf(z)*(upper_bound−lower_bound) (Equation 23).

The enhanced process 800 scores assets, e.g. real estate assets 132, such as but not limited to residential properties and markets, based upon a statistical analysis of one or properties 132 within a population of data 82, wherein the resultant scores 818 take into consideration the intended investment strategy of the investor e.g. such as an agent or client CLNT, or a customer CST.

An exemplary enhanced property score 818, such as available as a HomeScore™ 818, available through SmartZip Inc., of Pleasanton, Calif., comprises a relative rating of the investment potential of a property 132 for buyers purchasing a home to live in it, wherein the enhanced score 818 is based on a risk-adjusted financial assessment of the property's projected appreciation and expenses over a 10-year holding period.

An enhanced property score 818 may preferably have a relative scale, e.g. scale of 1-100, wherein all properties 132 nationwide may preferably be stack-ranked, such that 50 is the national average, wherein properties 132 that score above 50 are expected to outperform the market, while those that score below 50 are expected to underperform. In some system embodiments, an enhanced property score between 35 and 65 may preferably be considered a “good” investment.

The enhanced property score 818 is weighted to reflect the predicted appreciation and income for a property 132, along with any determined risks, such as due to uncertainty. For example, for a property 132 that has a predicted rent income of $2,500 to $5,000 per month, such as based on a determination of rent from comparable properties in a surrounding area, there is more uncertainty than for another property that has a predicted rent income of $3,000 to $3,500 per month. Such variances are readily reflected in the enhanced property score 818.

A prospective residential buyer in the market for a home may primarily be looking at a residential property 132 as their primary residence, i.e. they may primarily be looking for a ‘nice home’ to raise a family. However, at the time of a purchase or sale, such an investment is financially represented by its affordability or unaffordability. A residential buyer therefore may consider the average price growth of a property 132 at the time of sale, as most residential buyers seek to minimize their financial risk.

In contrast to many residential buyers that are looking for a property to use as their primary residence, and income investor may preferably seek cash flow from a property 132, e.g. monthly dividends or rent.

Therefore, while both a residential buyer and an income investor may seek to minimize risk, their tolerance for risk may be very different.

The computation of return at step 810 may preferably take into account any of price growth (appreciation), rental income, and expenses, wherein the expenses may comprises any of maintenance, vacancy, property tax, home owner's association (HOA) fees, property management fees, closing costs, sales commissions, and/or expense penalties, e.g. one-time fees for real estate owned (REO) properties.

The enhanced asset scoring process 800 can also take into account the tax implications for different types of investors. For example, the tax treatment is often different between an owner and an investor, e.g. an owner may realize savings on their income taxes, while an investor typically considers depreciation, e.g. assuming a 1031 exchange at the time of sale. As well, the treatment of expenses, e.g. home owner's association (HOA) fees, and/or property management (PM) fees), are different between an owner and an investor. While such expenses may be treated similarly between an owner and an investor, some income may be treated the same, e.g. such as rent received, which may reflect savings for an owner, and income for an investor.

Other tax implications that can be taken into account within the enhanced asset scoring process 800 may comprise any of:
landlord federal taxes on any of rent, depreciation, mortgage, taxes, and/or maintenance, e.g. assuming a 1031 exchange at sale, with no capital gains tax; and/or
owner federal taxes, such as mortgage and/or property taxes, wherein deductibility is limited.

The enhanced asset scoring process 800 may further comprise a step for inputting detailed user inputs, such as specific financial information from an owner or investor for entry of other income, expenses, and/or deductions, which can alter a score 818 that is customized for the user. For example, the alternate minimum tax (AMT) may be applicable to an individual, such as based upon a property tax deduction. As well, the process 800 may preferably input and take into account interest deductibility limitations, and/or standard deduction limitations.

As discussed above, an investment may preferably be represented by its unaffordability within the enhanced scoring system and process 800. For example, when the net present value (NPV) is calculated at step 808, the step may further comprise the steps of:
determining the total present value, wherein the total present value comprises a time-series of cash inflows and/or outflows;
discounting each of the inflows and outflows back to the current value of the asset; and
summing the discounted inflows and outflows back to the current value to yield the net present value (NPV).

The enhanced net present value calculation 808 may further apply different discount rates, based upon the type of investment. For example, a three percent discount may preferably be applied to a growth investment, a five percent discount may preferably be applied to an owner investment, and an eight percent discount may preferably be applied to an owner investment. In this example, the growth investment has the lowest applied discount, since a growth investment is the most impatient of the investment strategies.

As discussed above, the calculation of returns at step 810 takes into account the cash invested, which for a property 132 may be estimated as:

Cash Invested=(0.2*Purchase Price)+Closing Costs+Penalty to Fix-up Foreclosures (Equation 24).

The enhanced scoring process 800 may also preferably take into account risks or variance that are based on price appreciation, e.g. the volatility of price growth based on one or more price indices (HPI). The enhanced scoring process 800 may also take into account risks or variance based on cash flow. For example, rent may account for as much as twenty percent of the volatility of the price appreciation for a property 132, and maintenance expenses or vacancy for a property 132 may substantially affect cash flow.

The output score 818 of the enhanced scoring process 800 may further be dependent on other factors, such as based on any of similarities between one or more properties 132 within a group of properties 132, e.g. a census tract 142; school ratings; crime ratings; lifestyle ratings; consumer spending; and/or statistical property clusters 412 (FIG. 15).

For example, the characteristics of one or more properties 132, such as for a census tract 142, may be input within a data matrix, such as based on Census data, e.g. 2000 census data. Exemplary characteristics that may be considered my comprise any of median income, fraction of owner-occupied units, fraction of employed males in construction, manufacturing, and/or agriculture; latitude and longitude; and/or fraction of people working in Top-7 employment counties.

The output score 818 may preferably consider clusters of different groups of data, e.g. census tracts 142, that are considered to be similar. While clustering between groups of data may preferably depend on a variety of attributes that may be similar, the geospatial distance, e.g. latitude and longitude, between properties 132 may be more heavily weighted than other attributes. For example, for a property 132 that is equidistant to two other properties 132, attributes other than distance will more determine the strength of the grouping. If a property 132 is closer to a second property than to a third property, the attributes of the second property, even if dissimilar, are overridden by the weight attached to the geospatial proximities.

As also seen in FIG. 29, an enhanced price value or score 822 may preferably be determined, such as based at least in part on the enhanced score 818. For example, a user USR, client CLNT, or customer CST may desire to determine a sales price that is optimal for a property, such as to determine an accurate current value, e.g. relative to a local geography or market, and/or to determine how pricing a property will affect the time to sell. The enhanced score 818 can readily be compared to the enhanced scores 818 of comparable properties 132, to determine whether a proposed sales price yields a price score 822 that is comparable to the neighborhood, such as compared to properties 132 having similar attributes.

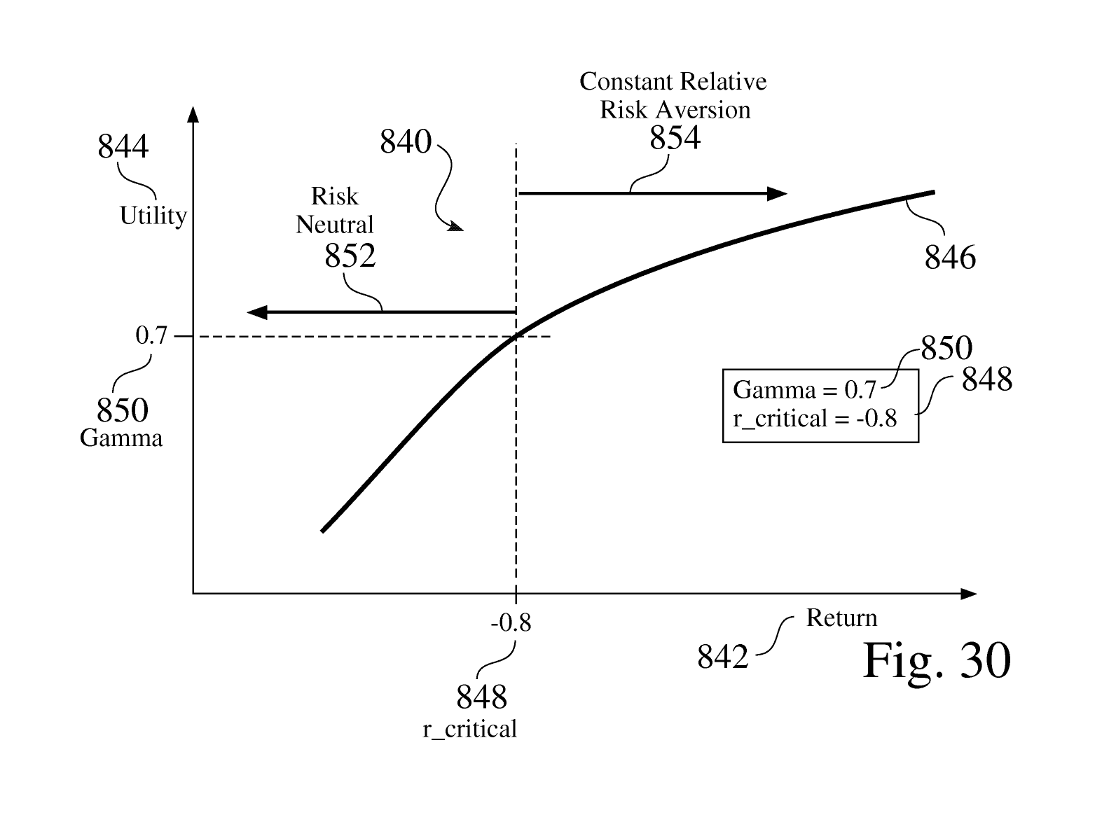

Specification of Utility Function. FIG. 30 is an exemplary graph 840 showing utility 844 of an asset 132 as a function of return 842, for gamma=0.7, and r_critical=−0.8. As discussed above, step 814 in the process 800 solves for Z that is based upon a calculated utility function U, which is based at least in part on upon comparable assets, e.g. 132.

The utility function u(return) has two parameters, gamma 850 (FIG. 30) and r_critical 848 (FIG. 30), wherein Gamma≧0, gamma<>1; and r_critical<0. The score returned at step 814 can take any value, and is expressed as a decimal. If the return is greater than r_critical, U(return) may be represented as:

$$U ( r ) = \frac{{( 1 + r )}^{1 - γ} - 1}{1 - γ} . \qquad ( Equation 25 )$$

If the return is less tan or equal to r_critical, U(return) may be represented as:

$$U ( r ) = ( {( 1 + {r}_{critical} )}^{- γ} * ( r - {r}_{critical} ) ) + \frac{{( 1 + {r}_{critical} )}^{1 - γ} - 1}{1 - γ} . \qquad ( Equation 26 )$$

This function has constant relative risk aversion for return >r_critical, and is risk-neutral (linear function) for returns <r_critical. It is seen that U(0)=0, such that the function is continuously differentiable.

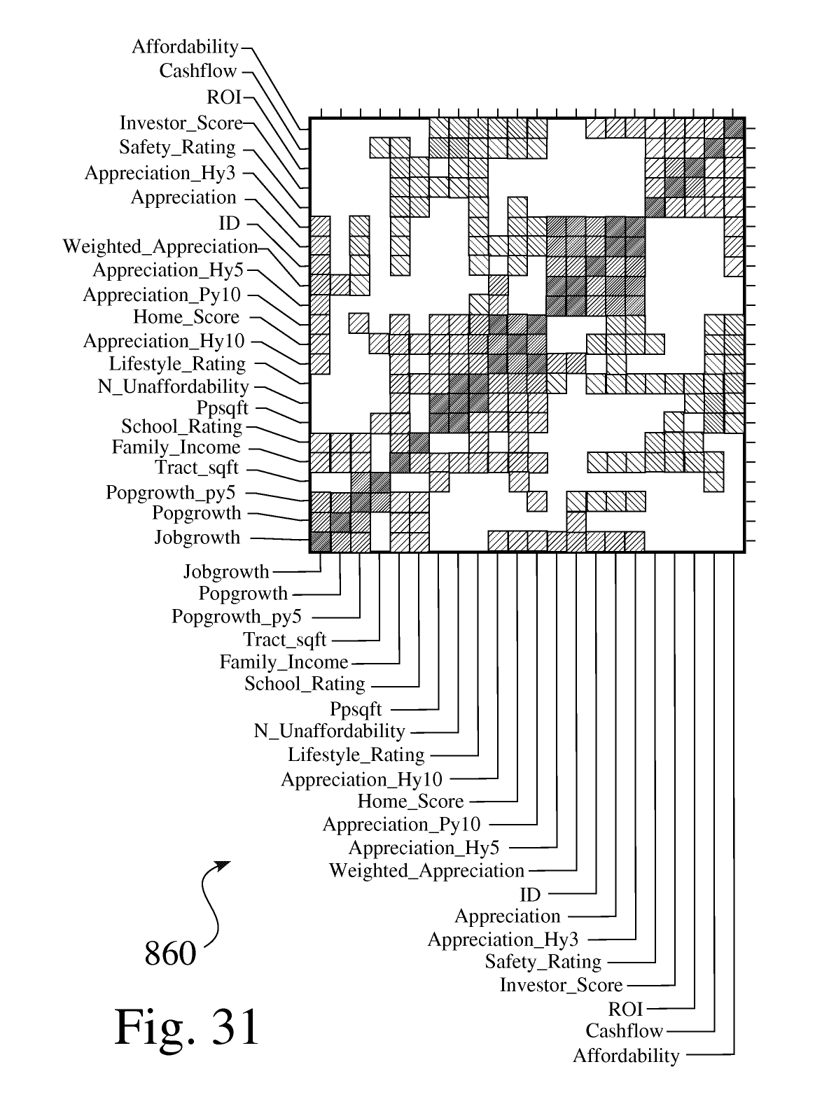

Differentiating Smart Zip Home and Investor Scores. FIG. 31 is a correlation matrix 860 for assets, wherein comparative values of a large number of attributes 83 of a property may efficiently be displayed and reviewed by a user USR. For example, a relative value of an attribute 83 may be correlated to other attributes 82, and may readily be stored, accessed, and/or displayed, such as to indicate correlations between any of affordability; cash flow; return on investment (ROI); investor score; safety rating; Historic Appreciation over last 3 years; general Forecast Appreciation value; Property Identifier; Weighted Appreciation; Historic Appreciation over last 5 years; Predicted Appreciation over next 10 years; Enhanced Home Score 818; Historic Appreciation over last 5 years; Lifestyle Rating; Unaffordability Prediction Value; People per Square Foot; School Rating; Family Income; Tract Area (Sq. Ft.); Predicted Population Growth; and/or Predicted Job Growth.

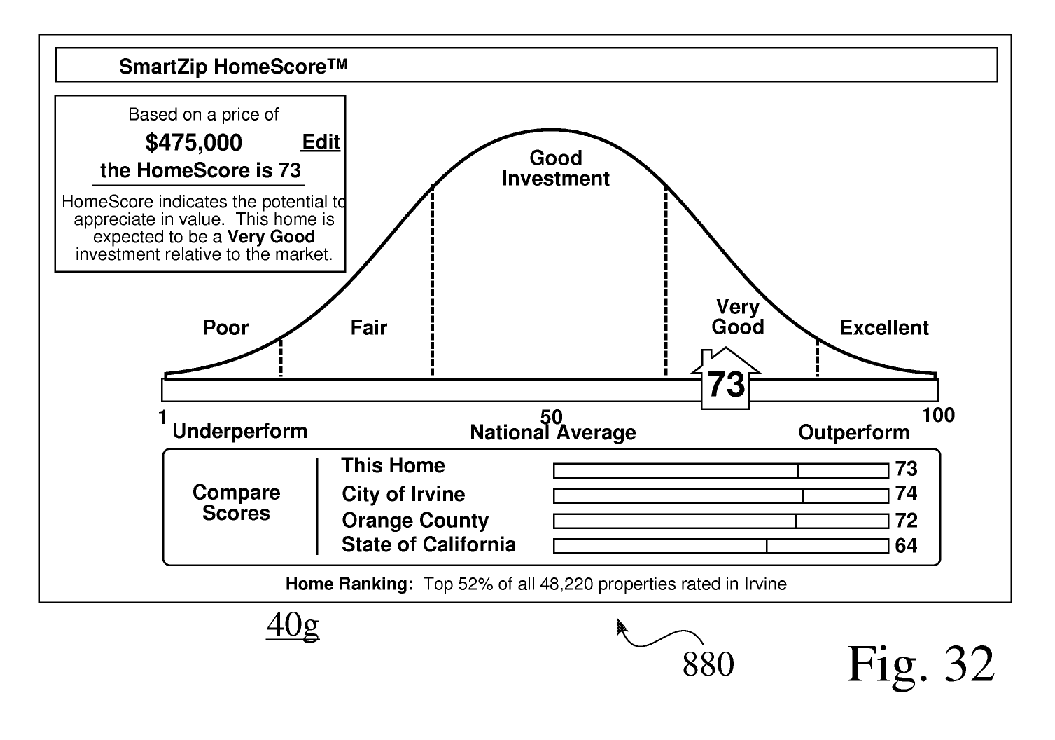

FIG. 32 is an exemplary enhanced rating display 880 for an asset within an exemplary enhanced user interface 40g or alternately in other delivered output, e.g. a document, which comprises a comparison of the enhanced rating or score, e.g. 818, of the asset 132 to comparable assets 132 within different statistical regions 194, e.g. city 140, county 146, and state 148.

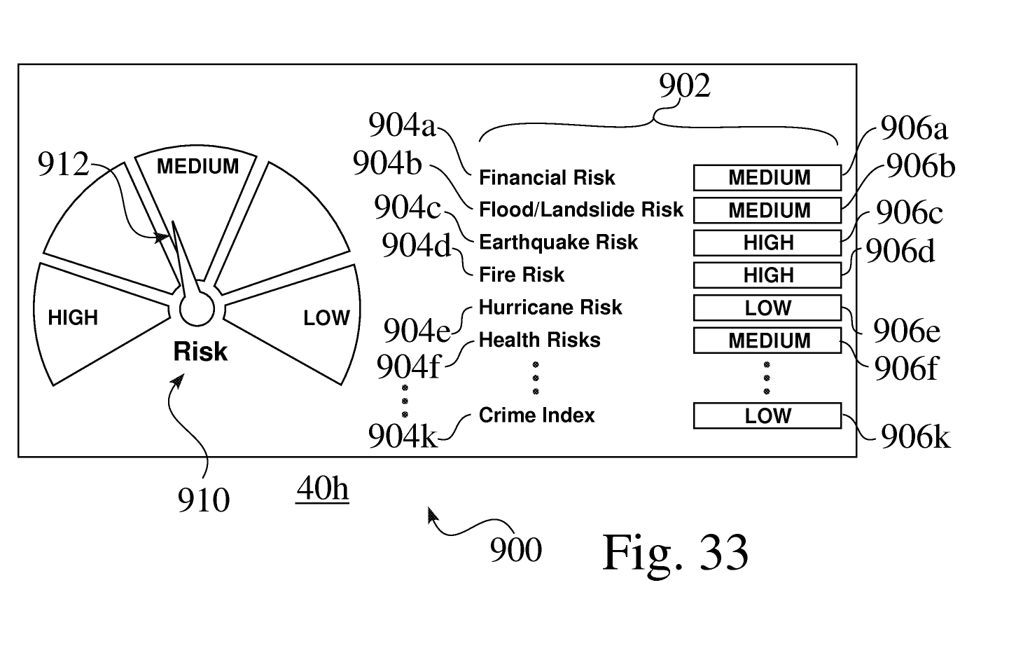

FIG. 33 shows an enhanced display 900 of enhanced risk ratings 902 associated with a property 132 within an exemplary enhanced user interface 40h or alternately in other delivered output, e.g. a document. For example, a display of risk ratings 902 may preferably reflect the attractiveness of home prices and lifestyle for one or more properties 132. The exemplary risk ratings 902 seen in FIG. 33 may comprise any of financial risk 904a, flood and/or landslide risk 904b, earthquake risk 904c, fire risk 904d, hurricane and/or tornado risk 904e, health risks 904f, and/or crime risks 904k.

For each of the displayed risk factors 904, e.g. 904a, a relative risk value 906, e.g. 906a may typically be displayed, such as to indicate any of a low, medium or high risk value 906. For the exemplary property seen in FIG. 33, such as for a home located in the hills overlooking Berkeley, Calif., there is a medium financial risk value 906a, a medium flood/landslide risk value 906b, a high earthquake risk value 906c, a high fire risk value 904d, a low hurricane risk value 906e, a medium health risk value 906f, and a low crime index value 906k.

The relative financial risk value 904a may preferably reflect the price volatility and/or distress for the property 132. The relative environmental risks 904 may preferably reflect risks associated with any of earthquakes, hurricane, tornado, fires, floods, wind, or weather. An exemplary health risk value 906f may reflect relative health risks 904f associated with any of air pollution, water quality, ozone, lead, carbon monoxide, nitrous oxide, asbestos, or neighboring toxic sites, e.g. proximity top one or more Superfund sites. An exemplary crime risk value 906k may reflect relative risks 904k associated with any of overall crime, property crime, violent crime, or proximity to known sex offenders.

As also seen in FIG. 33, an overall risk value 912 associated with a property 134 may preferably be displayed 910, such as to indicate the overall level of expected risk associated with buying and living at the corresponding address 132.

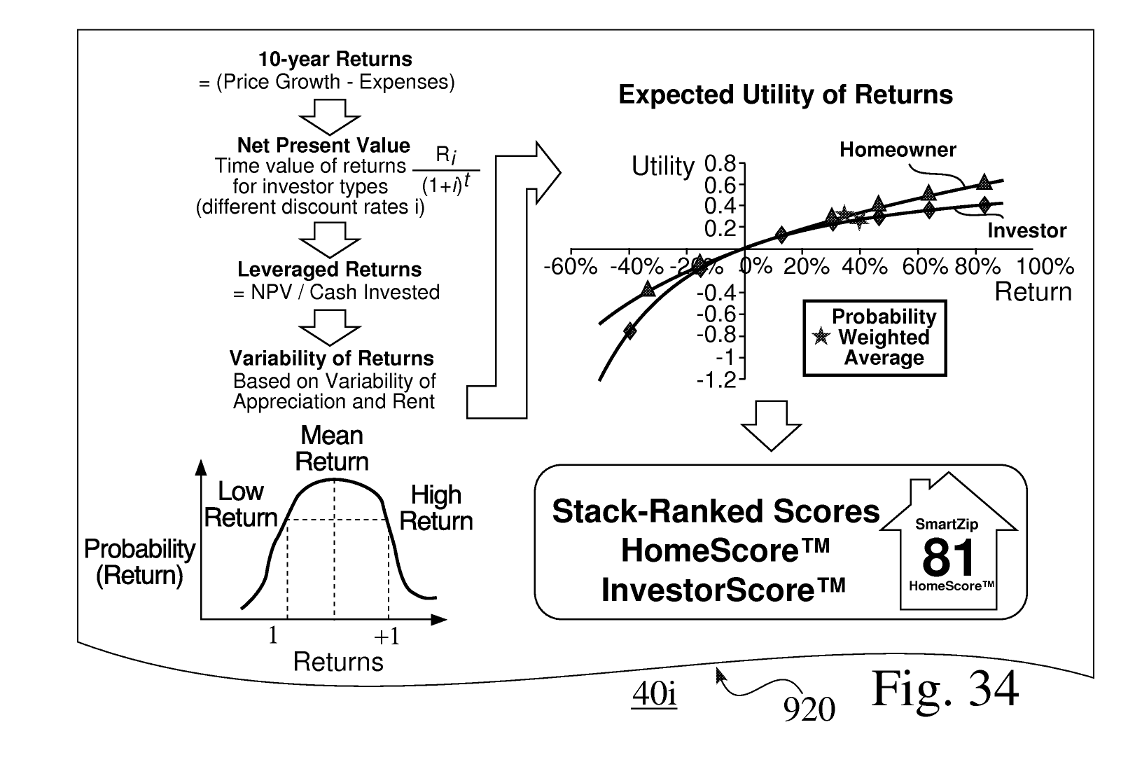

FIG. 34 shows an enhanced display 920 of financial analysis within an exemplary enhanced user interface 40i or alternately in other delivered output, e.g. a document.

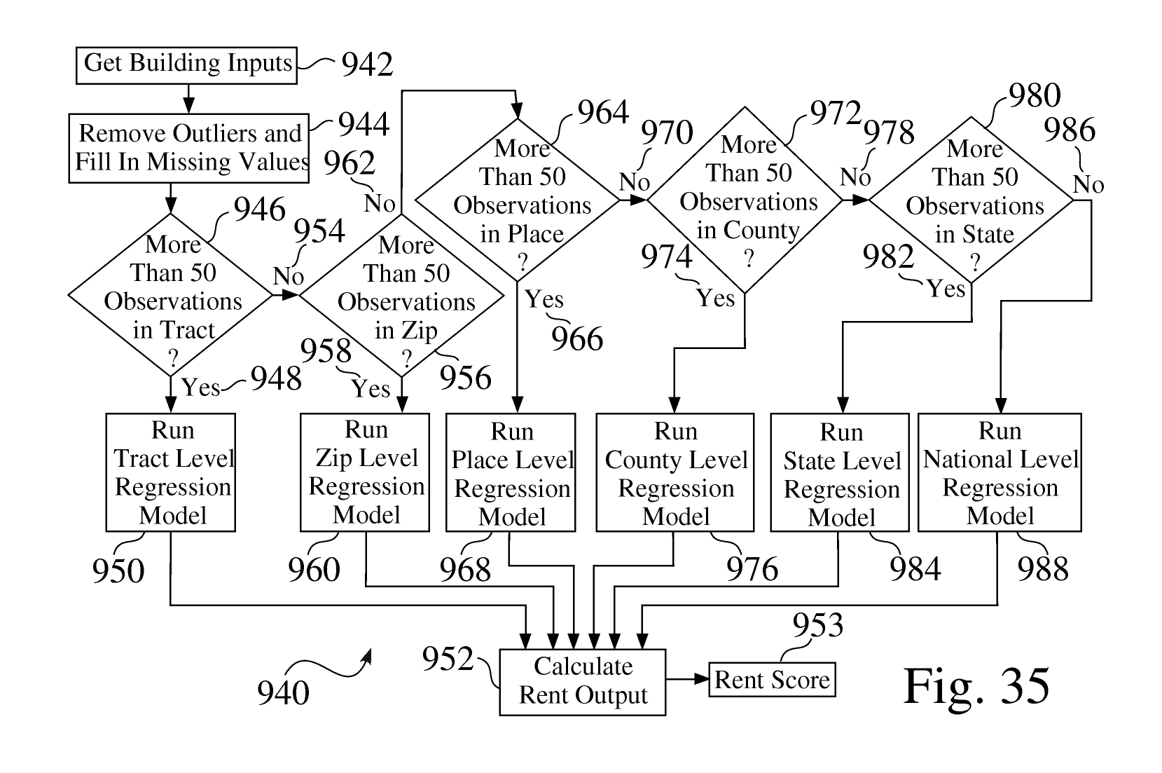

System and Process for Determining an Enhanced Rental Score. FIG. 35 is a flowchart for an exemplary process 940 to determine an enhanced rental score 953. At step 942 inputs building information that comprises independent variables, such as but not limited to property level attributes 83, e.g. property type, number of bedrooms, square feet, lot size, year built, and valuation, e.g. calculated AVM. Step 942 may also preferably input Zip Code level attributes, such as but not limited to any of median family income, census 2000 rent, and/or school rating. At step 942, the process removes statistical outliers, and fills in missing values, by using higher geographic overlay values.

The exemplary process 940 seen in FIG. 35 then proceeds to determine a minimum sufficient geography, e.g. containing no fewer than 50 records, with which to run a regression model to yield sufficient process coefficient and intercept estimates. For example, the process 940 first determine 946 if there are more than fifty observation records within the corresponding census tract 142. If so 948, the process 940 runs 950 a tract level regression model to generate tract level coefficients and average residual, i.e. offset, and then uses the census track level coefficients, together with all property and zip level attributes, to generate rents for all of the properties 132 of interest.

If the determination 946 is negative 954, the process determines 956 if there are more than fifty observation records within the corresponding zip level 144. If so 958, the process 940 runs 960 a zip level regression model to generate zip level coefficients and average residual, i.e. offset, and then uses the zip level coefficients, together with all property and zip level attributes, to generate rents for all of the properties 132 of interest.

If the determination 956 is negative 962, the process determines 964 if there are more than fifty observation records within the corresponding place or city 140. If so 966, the process 940 runs 968 a place level regression model to generate place level coefficients and average residual, i.e. offset, for each zip in the place or city 140, and then uses the place level coefficients, together with all property and zip level attributes, to generate rents for all of the properties 132 of interest.

If the determination 964 is negative 970, the process determines 972 if there are more than fifty observation records within the corresponding county 146. If so 974, the process 940 runs 976 a county level regression model to generate county level coefficients and average residual, i.e. offset, for each zip in the county 146, and then uses the county level coefficients, together with all property and zip level attributes, to generate rents for all of the properties 132 of interest.

If the determination 972 is negative 978, the process determines 980 if there are more than fifty observation records within the corresponding state 148. If so 982, the process 940 runs 984 a state level regression model to generate state level coefficients and average residual, i.e. offset, for each zip in the state 148, and then uses the state level coefficients, together with all property and zip level attributes, to generate rents for all of the properties 132 of interest.

If the determination 980 is negative 986, the process 940 runs 988 a nation level regression model to generate nation level coefficients and average residual, i.e. offset, for each zip in the nation 154, and then uses the nation level coefficients, together with all property and zip level attributes, to generate rents for all of the properties 132 of interest.

Step 952 therefore uses whatever coefficients are available, such as based on census tract 142, zip code 144, place or city 140, county 146, state 148, or nation 154, together with all property and zip level attributes to generate rents for all properties of interest, such as shown:

$$Rent = intercept + coef\_ptype * ptype + coef\_bedrooms * beds + coef\_log \_sqft * LOG ( sqft ) + coef\_log \_income * LOG ( median\_income ) + coef\_log \_census2000 \_rent * LOG ( census2000\_rent ) + coef\_avg \_school * school\_rating + off\_set . \qquad ( Equation 27 )$$

Given a minimum sufficient geography has been determined, containing no fewer than 50 records, the process 940 estimates the appropriate regression model to yield coefficient and intercept estimates. These estimated values are then used to generate 952 predicted rents for each property 132 in the geography of interest.

Alternate Rating or Scoring Systems and Processes. The enhanced scoring systems 20 and associated processes may readily be applied to a wide variety of applications.

For example, the enhanced scoring system 20 may preferably be used to determine and output an enhanced school rating at a property and/or neighborhood level, wherein the enhanced school rating is based on finding the a set of nearest (Euclidean distances) schools from a property, and then verifying that the extracted school set is falling within the elementary, middle, high school or integrated school district boundaries belonging to the property 132. Every school in the nation 154 may preferably be scored, such as with data acquired from the Department of Education and school districts. Each school is then stack ranked relative to the state 148. The filtered set of nearest school scores belonging to a property 132 are aggregated, and each house 132 is assigned a score. Then, a neighborhood score is computed as the arithmetic mean of all properties 132 in a neighborhood.

In another alternate embodiment, the enhanced scoring system 20 may preferably be used to determine and output an enhanced Leading Indicator Rating Index, which is based on the economic activities of supply and demand of listed properties 132, recent loan information, sales data, real-estate inventory, and overbought and oversold properties 132.

In yet another alternate embodiment, the enhanced scoring system 20 may preferably be used to determine and output an enhanced Lifestyle Index, which comprises a rating that is indicative of a location's attractiveness, based on several factors, e.g. such as including number of days of sunshine per year, and the concentration of local amenities, e.g. such as but not limited to retail establishments, community services, healthcare facilities, recreation, or arts, in a community that corresponds to any of a subject property 132, a ranking of economic class segmentation, e.g. lower, upper-lower, middle, upper-middle, upper, across neighborhoods in the United States 154. Exemplary comparative attributes that contribute to this index may comprise any of weather, expenditure, housing demand, and/or crime.

In addition, the enhanced scoring system 20 may preferably be used to determine and output a desirability index that comprises a composite index indicating the “attractiveness” of the properties 132 within a neighborhood, such as based on the enhanced Lifestyle Index, enhanced School Ratings, the enhanced housing price index (HPI), and other related factors.

The enhanced scoring system 20 and associated processes may preferably be used to determine and output a wide variety of other ratings or indicators, such as but not limited to any of market ratings or security ratings.

The enhanced systems 20 and processes disclosed herein advantageously capture the knowledge of vertical taxonomies, i.e. grouping and/or classifications, such as for valuations, ratings and predictive targeting, and facilitate data acquisition from any of the online and offline sources, to create models, business rules, predictions, lead management and client success and support systems.

While some of the exemplary enhanced systems and processes disclosed herein are related to real estate and/or sales, it should be understood that the enhanced systems and processes may readily be applied to a wide variety of vertical systems and markets.

Accordingly, although the invention has been described in detail with reference to a particular preferred embodiment, persons possessing ordinary skill in the art to which this invention pertains will appreciate that various modifications and enhancements may be made without departing from the spirit and scope of the disclosed exemplary embodiments.

1. A process, comprising the steps of:
calculating a forecast appreciation and related variance for one or more assets;
calculating forecast expenses and variances for the assets;
estimating a normal distribution of returns for each of the assets;
calculating the net present value for each of the assets;
calculating the predicted return for each of the assets;
transposing the calculated predicted return for each of the assets;
solving for z in the equation utility (R_{state}−z)=utility, for each of the assets;
transforming z to obtain a relative score for the each of the assets; and
outputting the score for display to a user.

2. The process of claim 1, wherein each of the assets comprise real estate properties.

3. The process of claim 2, wherein the forecast expenses comprise any of rent, vacancy, or other property expenses.

4. The process of claim 3, wherein the step of calculating the net present value for each of the assets further comprises the step of:
running a plurality of statistical scenarios to forecast a normal distribution, wherein the statistical scenarios are related to any of the forecast appreciation, the forecast rent, the forecast vacancy, or the forecast other expenses.

5. The process of claim 1, wherein the step of calculating the net present value for each of the assets further comprises the step of:
applying a discount rate that is based on an intended investment strategy.

6. The process of claim 5, wherein the discount rate for an intended investment strategy based on income has a first discount level, and wherein the discount rate for an intended investment strategy based on growth has a second discount level, wherein the second discount level is lower than the first discount level.

7. The process of claim 1, wherein the predicted return for each of the assets is equal to the net present value divided by the equity for each of the corresponding assets.

8. The process of claim 1, wherein the step of transposing the calculated predicted return for each of the assets comprises taking the log of a constant relative risk aversion utility function.

9. The process of claim 1, wherein the relative score comprises a number between 0 and 100.

10. The process of claim 9, wherein the scores of all of the assets are stack ranked, wherein an average relative score is 50.

11. The process of claim 10, wherein assets that score above 50 are expected to outperform a market, while assets that score below 50 are expected to underperform the market.

12. The process of claim 10, wherein a relative score between 35 and 65 is considered to be a good investment.

13. A system implemented over a network, wherein the system comprises:
a user interface; and
one or more processors that are connectable to the network, wherein at least one of the processors is linked to the user interface, and wherein at least one of the processors is configured to
calculate a forecast appreciation and related variance for one or more assets,
calculate forecast expenses and variances for each of the assets,
estimate a normal distribution of returns for each of the assets,
calculate the net present value for each of the assets,
calculate the predicted return for each of the assets,
transpose the calculated predicted return for each of the assets,
solve for z in the equation utility (R_{state}−z)=utility, for each of the assets,
transform z to obtain a relative score for the each of the assets, and
provide an output to display the relative score for one or more of the assets to at least one user through the user interface.

14. The system of claim 13, wherein each of the assets comprise real estate properties.

15. The system of claim 14, wherein the forecast expenses comprise any of rent, vacancy, or other property expenses.

16. The system of claim 15, wherein at least one of the processors is configured to run a plurality of statistical scenarios to forecast a normal distribution, wherein the statistical scenarios are related to any of the forecast appreciation, the forecast rent, the forecast vacancy, or the forecast other property expenses.

17. The system of claim 1, wherein at least one of the processors is configured to apply a discount rate that is based on an intended investment strategy.

18. The system of claim 17, wherein the discount rate for an intended investment strategy based on income has a first discount level, and wherein the discount rate for an intended investment strategy based on growth has a second discount level, wherein the second discount level is lower than the first discount level.

19. The system of claim 13, wherein the predicted return for each of the assets is equal to the net present value divided by the equity for each of the corresponding assets.

20. The system of claim 13, wherein the transposed calculated predicted return for each of the assets comprises the log of a constant relative risk aversion utility function.

21. The system of claim 13, wherein the relative score comprises a number between 0 and 100.

22. The system of claim 21, wherein the scores of all of the assets are stack ranked, wherein an average relative score is 50.

23. The system of claim 22, wherein assets that score above 50 are expected to outperform a market, while assets that score below 50 are expected to underperform the market.

24. The system of claim 22, wherein a relative score between 35 and 65 is considered to be a good investment.
